(19) United States
(12) Patent Application Publication
(10) Pub. No.: US 2012/0254036 A1
(43) Pub. Date: Oct. 4, 2012

(54) INFORMATION PROCESSING DEVICE AND METHOD, PROGRAM AND INFORMATION PROCESSING SYSTEM

(75) Inventor: Yoshinobu Ito, Chiba (JP)

(73) Assignee: SONY CORPORATION, Tokyo (JP)

(21) Appl. No.: 13/424,599

(22) Filed: Mar. 20, 2012

(30) Foreign Application Priority Data
Mar. 30, 2011 (JP) 2011-075961

(51) Int. Cl. G06Q 20/40; H04B 7/24

(52) U.S. Cl. 705/44; 455/41.2

(57) ABSTRACT

An information processing device includes a communication device detection section which detects a communication device which performs proximity communication and a common processing section which performs common processing with regard to a plurality of the communication devices based on unique information which are acquired from the communication devices which are detected in a case where the plurality of communication devices are detected.

### BACKGROUND

The present technology relates to an information processing device and method, a program, and an information processing system, and particularly relates to an information processing device and method, a program, and an information processing system which are able to improve the convenience of a service which uses proximity communication.

In recent years, various services such as payment systems and a labor management system which use a contactless IC card (referred to below as simply an IC card) are wide spread. In systems such as these, one-to-one communication between an IC card and a reader/writer is assumed. As a result, for one reader/writer to communicate with a plurality of IC cards, there is a necessity for the plurality of IC cards to be placed a plurality of times with regard to the reader/writer. When the example of payment is taken, the number of IC cards which is placed in one payment is one, and placing n times is necessary in order to make n payments.

In addition, a contactless IC card system is proposed where the data is written in at the same time together with regard to the plurality of IC cards and the data is read out and written according to each single individual card (for example, Japanese Unexamined Patent Application Publication No. 2001-307047).

### SUMMARY

However, with the technology in the related art, only the writing in of the data with regard to the plurality of IC cards is simply performed together, and services, which are able to be provided using proximity communication which uses a technique such as this, are limited.

It is desirable that the convenience of the service which uses proximity communication is improved in a case where a plurality of IC cards is placed.

According to an embodiment of the present technology, there is provided an information processing device which is provided with a communication device detection section which detects a communication device which performs proximity communication and a common processing section which performs common processing with regard to a plurality of the communication devices based on unique information which are acquired from the communication devices which are detected in a case where the plurality of communication devices are detected.

A processing result notification section, which notifies the plurality of communication devices of the result of the common processing, may be further provided.

The common processing section may perform the common processing according to the number of communication devices which has been detected and the unique information which are acquired from the communication devices and may determine a value which is requested with regard to each of the communication devices.

The unique information may be information which indicates the balance of electronic money and the common processing section may determine the monetary amount as the payment amount for each of the communication devices in a case where the balances which is acquired for each of the communication devices exceed the monetary amount for splitting the costs which are acquired by dividing the amount to be paid by the number of communication devices.

The unique information may be information which indicates the monetary amount of the electronic money which is able to be charged and the common processing section may determine the monetary amount as the charge amount for each of the communication devices in a case where the monetary amount able to be charged which is acquired for each of the communication devices exceeds the monetary amount which is acquired by dividing the charge amount by the number of communication devices.

The unique information may be information which indicates the balance of electronic money and the common processing section may determine the payment amount according to the balances for each of the communication devices in a case where the monetary amount which is acquired by combining the balances which are acquired for each of the communication devices exceeds the amount to be paid.

The common processing section may perform the common processing in a case where the previous processing is completed in a normal manner in one or more of the communication devices out of the plurality of communication devices which are detected.

An error notification section, which notifies of an error which is generated when the detection of the communication devices, the common processing, or the notification of the result of the common processing is performed, may be further provided.

A display section, which displays a screen where the content of the common processing is selected, may be further provided.

According to another embodiment of the present technology, there is provided an information processing method and a program which are a method and a program which correspond to the information processing device according to the embodiment of the present technology which has been described previously.

In the information processing device, method and a program according to the embodiment of the present technology, the communication device which performs proximity communication is detected and the common processing is performed with regard to the plurality of the communication devices based on unique information which are acquired from the communication devices which are detected in a case where the plurality of communication devices are detected.

According to still another embodiment of the present technology, there is provided an information processing system which is formed from a communication device which performs proximity communication and an information processing device where the information processing device is provided with a communication device detection section which detects the communication device and a common processing section which performs common processing with regard to a plurality of the communication devices based on unique information which are acquired from the communication devices which are detected in a case where the plurality of communication devices are detected.

The communication device and the information processing device may be independent devices or may be internal blocks which configure one device.

In the information processing system according to the embodiments of the present technology, using the information processing device, the communication device is detected and the common processing is performed with regard to the plurality of the communication devices based on unique information which are acquired from the communication devices which are detected in a case where the plurality of communication devices are detected.

According to the embodiments of the present technology, it is possible to improve the convenience of services which use proximity communication.

### BRIEF DESCRIPTION OF THE DRAWINGS

FIG. 1 is a diagram illustrating a configuration example of an IC card payment system where the present technology is applied;

FIG. 2 is a diagram illustrating a configuration of an IC card;

FIG. 3 is a diagram illustrating a configuration of a POS terminal device;

FIG. 4 is a diagram illustrating a configuration of an IC card payment control program;

FIG. 5 is a diagram describing a flow of splitting the costs with electronic money;

FIG. 6 is a diagram describing a flow of combining of electronic money;

FIG. 7 is a diagram describing a flow of charging together with electronic money;

FIG. 8 is a diagram describing a flow of responses of store personnel with regard to a customer;

FIGS. 9A and 9B are diagrams illustrating an example of a payment selection screen;

FIG. 10 is a flowchart describing an IC card payment process;

FIG. 11 is a flowchart describing an IC card detection process;

FIG. 12 is a flowchart describing error processing;

FIG. 13 is a diagram illustrating causes and measure of errors;

FIG. 14 is a flowchart describing an IC card state confirmation process;

FIG. 15 is a flowchart describing a balance reference and payment amount determination process (payment: splitting the costs);

FIG. 16 is a diagram illustrating an example of a payment reselection screen;

FIG. 17 is a flowchart describing a balance reference and payment amount determination process (charging);

FIG. 18 is a flowchart describing a balance reference and payment amount determination process (payment: combining);

FIG. 19 is a flowchart describing a payment process;

FIG. 20 is a flowchart describing a payment process;

FIG. 21 is a flowchart describing a payment process;

FIG. 22 is a diagram illustrating a configuration example of an IC card data transfer system where the present technology is applied;

FIG. 23 is a diagram illustrating a configuration of a personal computer;

FIG. 24 is a diagram illustrating a configuration of an IC card data transfer control program;

FIG. 25 is a flowchart describing an IC card data transfer process;

FIGS. 26A and 26B are diagrams illustrating a configuration example of an IC card site induction system where the present technology is applied;

FIG. 27 is a diagram illustrating a configuration of an IC card site induction control program; and

FIG. 28 is a flowchart describing an IC card site induction process.

### DETAILED DESCRIPTION OF EMBODIMENTS

Below, the embodiments of the present technology will be described while referencing the diagram.

1. First Embodiment (IC Card Payment System)

2. Second Embodiment (IC Card Data Transfer System)

3. Third Embodiment (IC Card Site Induction System)

### 1. First Embodiment

### Configuration of IC Card Payment System

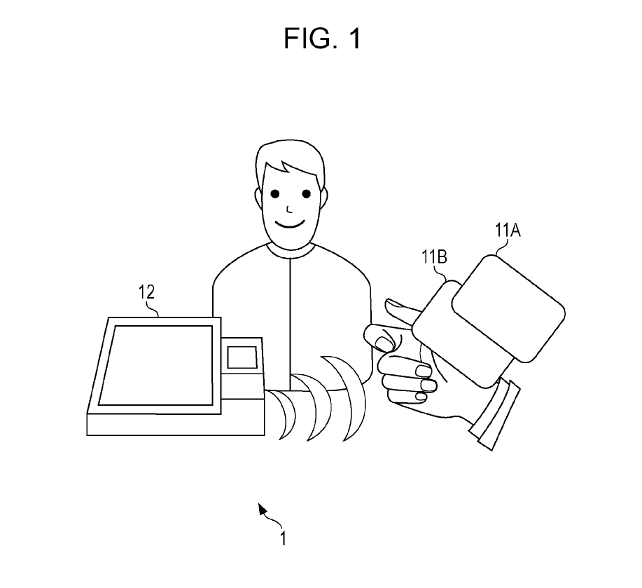

FIG. 1 is a diagram illustrating a configuration example of an IC card payment system where the present technology is applied.

As shown in FIG. 1, an IC card payment system 1 is configured from a plurality of IC cards 11 and a POS terminal device 12. Between the plurality of IC cards 11 and the POS terminal device 12, proximity communication using electromagnetic induction which uses transmission waves with a predetermined frequency is performed, and the transfer of data is performed without contact.

The POS terminal device 12 is disposed, for example, in a store, and payment is performed using electronic money on the plurality of the IC cards 11 which are placed by the customer who performs paying. In addition, the POS terminal device 12 performs charging of a desired monetary amount with regard to the plurality of IC cards 11 which are placed by the customer who performs charging (input of money).

Here, in FIG. 1, two IC cards 11A and 11B are shown as an example of the plurality of IC cards 11.

The IC card payment system 1 is configured as above.

### [Configuration of IC Card]

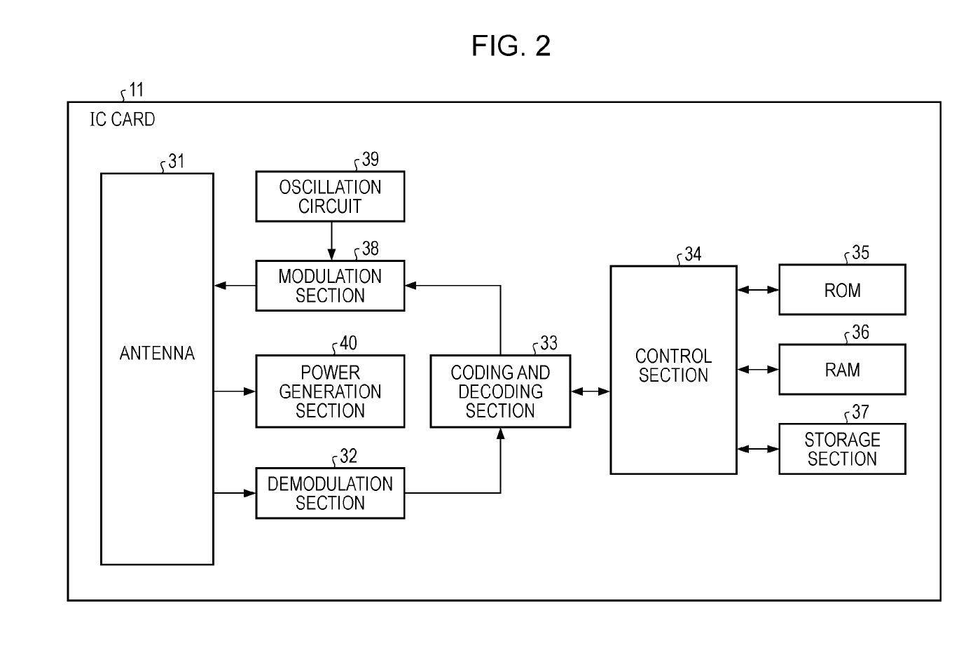

FIG. 2 is a diagram illustrating a configuration of the IC card 11.

As shown in FIG. 2, the IC card 11 is configured from an antenna 31, a demodulation section 32, a coding and decoding section 33, a control section 34, a ROM 35, a RAM 36, a recording section 37, a modulation section 38 and an oscillation circuit 39.

The antenna 31 receives a modulation wave which is transmitted from the POS terminal device 12 as a radio wave and is supplied to the demodulation section 32.

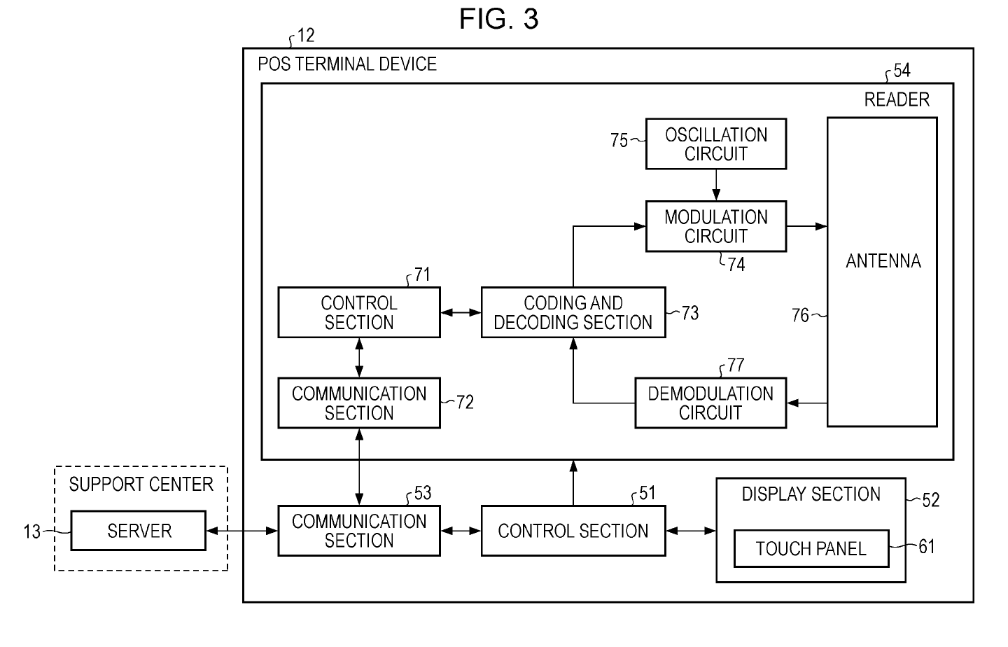

The demodulation section 32 demodulates data which is supplied from the antenna 31 using a demodulation method which corresponds to a modulation section 74 of FIG. 3 and the data which is acquired due to the demodulation is supplied to the a coding and decoding section 33.

The coding and decoding section 33 decodes the data which is supplied from the demodulation section 32 using a decoding method which corresponds to the coding and decoding section 73 of FIG. 3 and the data which is obtained due to the decoding is supplied to the control section 34.

The control section 34 controls the actions of each section of the IC card 11.

The control section 34 temporarily stores data in the RAM 36 and executes by reading out a program which is recorded in the ROM 35. Due to this, the control section 34 carries out a predetermined process with regard to the data which is supplied from the coding and decoding section 33 and records the data which is acquired due to this in the recording section 37.

The control section 34 acquires the data which is recorded in the recording section 37 and supplies to the coding and decoding section 33.

The coding and decoding section 33 codes the data which is supplied from the control section 34 using a coding method which corresponds to a coding and decoding section 73 of FIG. 3, and the data which is acquired due to the coding is supplied to the modulation section 38.

The modulation section 38 generates transmission waves based on a clock signal with a predetermined frequency which is supplied from the oscillation circuit 39. The modulation section 38 modulates the data which is supplied from the coding and decoding section 33 using the modulation method which corresponds to the demodulation section 77 of FIG. 3 based on the transmission waves which are generated, and the data which is acquired due to the modulation is supplied to the antenna 31.

The antenna 31 transmits the modulation waves which are supplied from the modulation section 38 to the POS terminal device 12 using proximity communication as a radio wave.

A power generation section 40 generates and supplies direct current power to each section of the IC card 11 based on the electromotive force of alternating current which is generated by the antenna 31.

The IC card 11 is configured as above.

### [Configuration of POS Terminal Device]

FIG. 3 is a diagram illustrating a configuration of the POS terminal device 12.

The POS terminal device 12 is configured by a control section 51, a display section 52, a communication section 53, and a reader/writer 54. In addition, the POS terminal device 12 is connected with a server 13 which is disposed in a support center via a predetermined communication network such as a dedicated line.

The control section 51 controls the action of each section of the POS terminal device 12.

The display section 52 displays a predetermined screen according to the control of the control section 51. In addition, the screen of the display section 52 overlaps with a touch panel 61. The touch panel 61 supplies position information which corresponds to the operation by receiving the operation of a user, who selects an operation screen which is displayed on the screen of the display section 52, to the control section 51.

The control section 51 supplies the data for transmitting to the IC card 11 or the server 13 to the communication section 53.

The communication section 53 supplies data which is supplied from the control section 51 to the reader/writer 54. In addition, the communication section 53 transmits the data which is supplied from the control section 51 to the server 13 via the predetermined network.

The reader/writer 54 transmits the data which is supplied from the communication section 53 to the IC card 11. In addition, the reader/writer 54 receives the data which is transmitted from the IC card 11 and supplies to the communication section 53.

The reader/writer 54 is configured from a control section 71, a communication section 72, a coding and decoding section 73, a modulation section 74, an oscillation circuit 75, an antenna 76, and a demodulation section 77.

The control section 71 controls the actions of each section of the reader/writer 54. In addition, the control section 71 acquires data which is supplied from the communication section 53 via the communication section 72 and supplies to the coding and decoding section 73.

The coding and decoding section 73 codes the data which is supplied from the control section 71 using a coding method which corresponds to a coding and decoding section 33 of FIG. 2, and the data which is acquired due to the coding is supplied to the modulation section 74.

The modulation section 74 generates transmission waves based on a clock signal with a predetermined frequency which is supplied from the oscillation circuit 75. The modulation section 74 modulates the data which is supplied from the coding and decoding section 73 using the modulation method which corresponds to the demodulation section 32 of FIG. 2 based on the transmission waves which are generated and the data which is acquired due to the modulation is supplied to the antenna 76.

The antenna 76 transmits the modulation waves which are supplied from the modulation section 74 to the IC card 11 using proximity communication as radio waves.

In addition, the antenna 76 receives the modulation waves which are transmitted from the IC card 11 by the proximity communication as radio waves and supplies to the demodulation section 77.

The demodulation section 77 demodulates the modulation waves which are supplied from the antenna 76 using a demodulation method which corresponds to the modulation method of the modulation section 38 of FIG. 2, and the data is supplied which is acquired by the demodulation is supplied to the coding and decoding section 73.

The coding and decoding section 73 decodes the data which is supplied from the demodulation section 77 using a decoding method which corresponds to the coding and decoding section 33 of FIG. 2, and supplies the data which is acquired by the decoding to the control section 71.

The control section 71 supplies the data which is supplied from the coding and decoding section 73 to the communication section 53 via the communication section 72.

The communication section 53 supplies the data which is supplied from the communication section 72 to the control section 51. The control section 51 performs predetermined processing with regard to the data which is supplied from the communication section 53.

The POS terminal device 12 is configured as above.

[Configuration of IC Card payment Control Program]

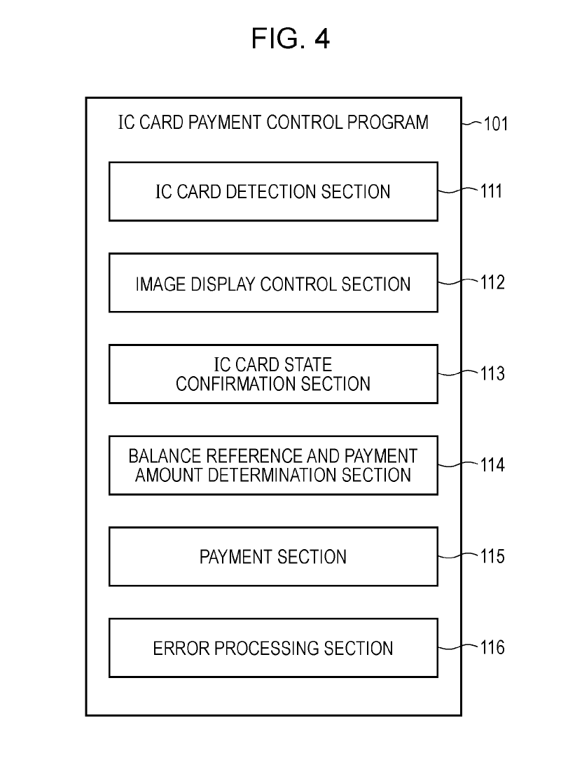

FIG. 4 is a diagram illustrating a configuration on an IC card payment control program 101.

The IC card payment control program 101 is executed by either the control section 51 or the control section 71.

The IC card payment control program 101 is configured from an IC card detection section 111, an image display control section 112, an IC card state confirmation section 113, a balance reference and payment amount determination section 114, a payment section 115, and an error processing section 116.

The IC card detection section 111 performs polling by controlling the reader/writer 54 and detects the IC card 11.

The image display control section 112 displays a predetermined screen which relates to a payment using the IC card 11 on the display section 52.

The IC card state confirmation section 113 confirms whether or not the previous payment process with regard to the IC card 11 was normally completed by controlling the reader/writer 54 in a case where a plurality of the IC cards 11 are detected by the IC card detection section 111.

The balance reference and payment amount determination section 114 acquires unique information which are acquired from the IC cards 11 by controlling the reader/writer 54 in a case where it is determined by the IC card state confirmation section 113 that the previous payment process of the one or more IC cards 11 was normally completed. The balance reference and payment amount determination section 114 performs common processing with regard to the plurality of IC cards 11 based on the unique information which are acquired.

As the common processing, a process is performed according to the number of IC cards 11 which are detected and the unique information which are acquired from each of the IC cards 11, and a value is determined which is requested with regard to each of the IC cards 11. Specifically, for example, a process for paying an amount to be paid by splitting the costs using electronic money on the plurality of IC cards 11 and a process for paying by combining the electronic money on the plurality of IC cards 11 as well as a process for charging with regard to the plurality of IC cards which will be described later are performed.

The payment section 115 performs payment for each of the IC cards 11 by notifying the IC cards 11 of a value which is determined for each of the IC cards 11 by the balance reference and payment amount determination section 114 along with the transaction ID by controlling the reader/writer 54. For example, a payment amount or a charge amount which corresponds to the transaction ID is notified to the plurality of IC cards 11.

The error processing section 116 notifies an error which is generated by the processes using the IC card detection section 111, the IC card state confirmation section 113, the balance reference and payment amount determination section 114, or the payment section 115.

The IC card payment control program 101 is configured as above.

### [Application Example of IC Card Payment System]

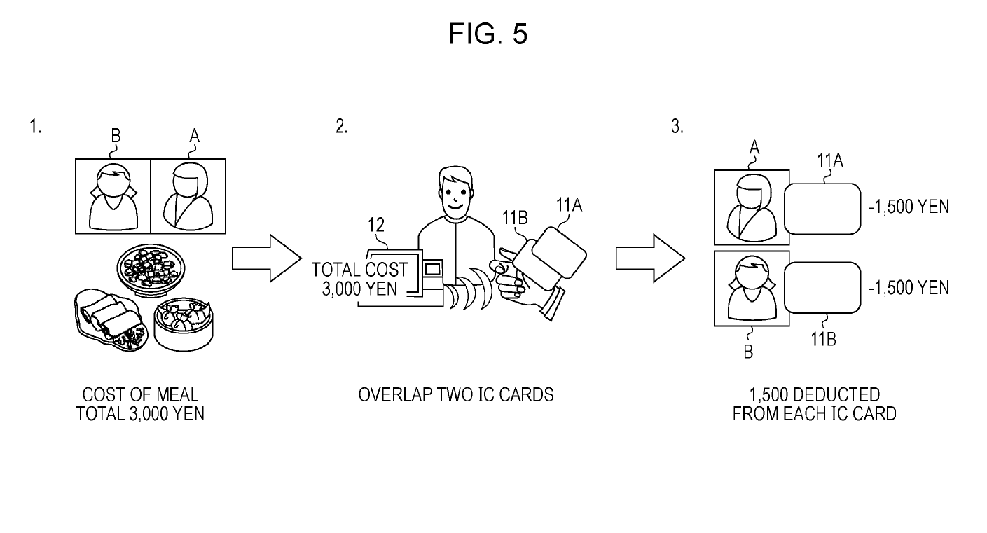

An application example of the IC card payment system 1 will be described with reference to FIGS. 5 to 9.

FIG. 5 is a diagram describing an example of paying using the plurality of IC cards 11 by equally splitting the amount to be paid.

For example, in a case where the costs when two people A and B have a meal is 3,000 yen, it is necessary for an IC card 11A of A and an IC card 11B of B to be individually placed during a payment system where only one of the IC cards 11 is placed at a time in a case where there is a desire to pay the costs by splitting. In the IC card payment system 1, by A and B overlapping the IC card 11A and the IC card 11B with regard to the POS terminal device 12, 1,500 yen which is a monetary amount when 3,000 yen is split is deducted from each of the two IC cards 11.

With a payment system where only one IC card 11 is able to be placed at a time, in a case where, continuing after A has performed payment by placing the IC card 11A, B performs payment by placing the IC card 11B, it may be considered that paying is not able to be performed when the balance of the electronic money on the IC card 11B is insufficient. On the other hand, in the IC card payment system 1, since payment is performed after confirming that there is balances where payment is possible in the IC card 11A and the IC card 11B, it is possible to prevent the circumstances where the balance of the electronic money on the IC card 11B is insufficient after the electronic money on the IC card 11A has been deducted.

In addition, compared to the case where the IC cards 11 are placed in order one at a time, since a representative places once by overlapping the IC cards 11 in the IC card payment system 1, there are merits for both the customers and store personal such as the resolution of crowding during paying and shortening of payment time. Furthermore, since there basically is a limit to the input of money in the IC card 11, there is a limit to the amount which is able to be paid using one IC card, but payment which exceeds the limit amount for inputting money is possible by placing a plurality of the IC cards 11 by overlapping.

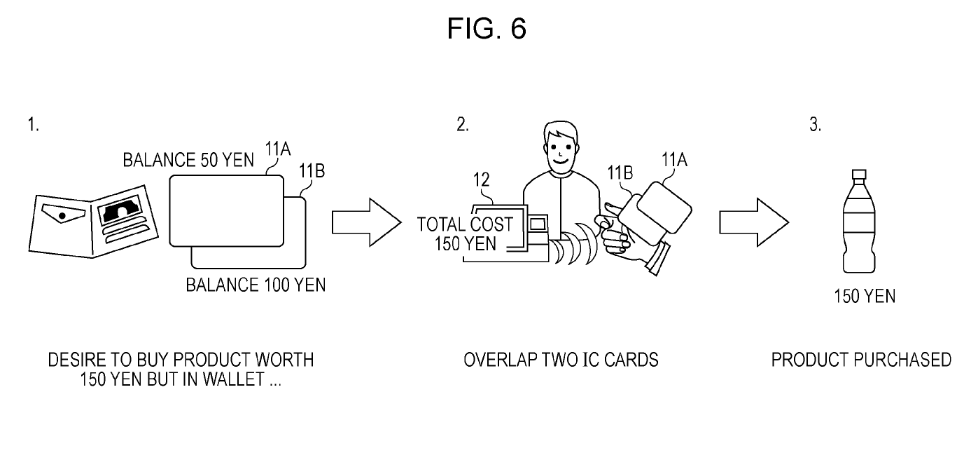

FIG. 6 is a diagram describing an example of paying by combining electronic money on a plurality of the IC cards 11.

For example, in a case where the balance on the IC card 11A is 50 yen and the balance on the IC card 11B is 100 yen and in a case where there is a desire to purchase a product worth 150 yen, the balance on either of the IC cards 11 is insufficient and the product is not able to be purchased when there is a payment system where the IC cards 11 are placed one at a time. In the IC card payment system 1, payment is performed using the monetary amount where the balances of the two IC cards 11 are combined by the IC card 11A and the IC card 11B being placed by overlapping with regard to the POS terminal device 12. Accordingly, the product worth 150 yen is able to be purchased.

When there is a payment system where the IC cards 11 are placed one at a time, the IC card 11A is placed and 50 yen is paid and then the IC card 11B is placed and 100 yen is paid, and as a result, it is necessary for the total of the balances of the two IC cards 11 to be confirmed as being 150 yen or more. On the other hand, in the IC card payment system 1, since the payment is performed only in the case where the total of the balances of the IC card 11A and the IC card 11B is 150 yen or more, the confirmation operation is not necessary. Due to this, it is expected that the payment time is shortened and the convenience is improved. In addition, it is possible to effectively use the remainders of the electronic money.

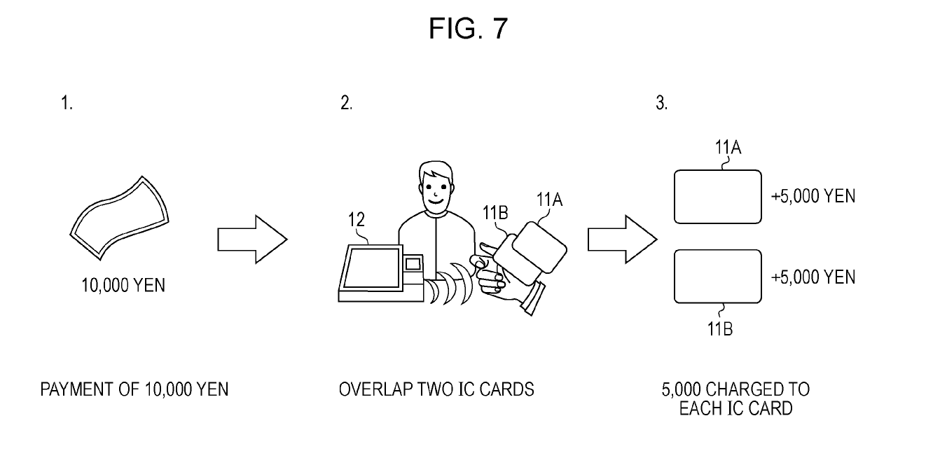

FIG. 7 is a diagram describing an example of performing charging with electronic money with regard to a plurality of IC cards 11.

For example, in a case where 5,000 yen each, a total of 10,000 yen is charged with regard to two IC cards 11 and in a case where there is a payment system where the IC cards 11 are placed one at a time, it is necessary for 5,000 yen to be charged individually with regard to the IC card 11A and the IC card 11B. On the other hand, in the IC card payment system 1, 5,000 yen is charged to each of the two IC cards 11 by the IC card 11A and the IC card 11B being placed by overlapping with regard to the POS terminal device 12.

In addition, without being limited to the charging of the IC cards 11, for example, it is possible to apply the usage method to where, in a case where a plurality of people desire to purchase entrance tickets, ticket information is written into all IC cards 11 by one person who is a representative collecting the IC cards 11 of each person and placing by overlapping with regard to the POS terminal device 12.

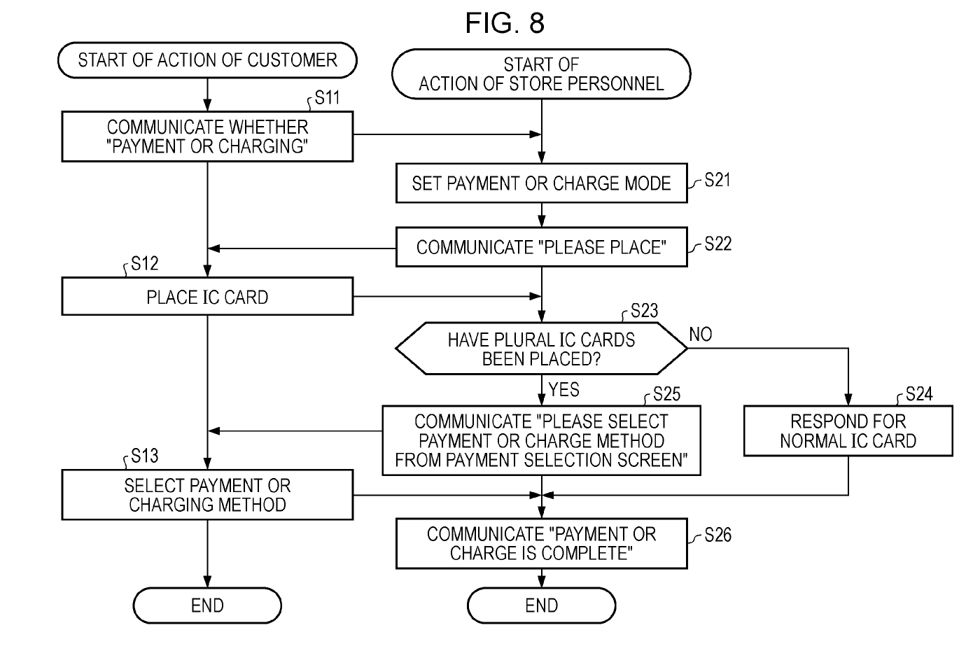

Next, a transaction which is performed between a customer and store personnel when examples of FIGS. 5 to 7 described above are realized will be described with reference to the flowchart of FIG. 8.

First, a customer communicates “payment or charge” with regard to store personnel (step S11). Here, the transaction is clear in an actual scene. On the other hand, the store personal sets the paying or charging mode by operating the POS terminal device 12 according to the instruction from the customer (step S21) and communicates “please place” with regard to the customer (step S22). Due to this, polling is started in the POS terminal device 12.

The customer places one or a plurality of IC cards 11 on the POS terminal device 12 according to the instruction from the store personnel (step S12). Whether one of the IC cards 11 is placed or a plurality is placed by overlapping is detected by the POS terminal device 12. The store personnel performs a normal response to the IC card 11 in a case where the one of the IC cards 11 is placed (“No” in step S23) and performs payment using one IC card 11 (step S24).

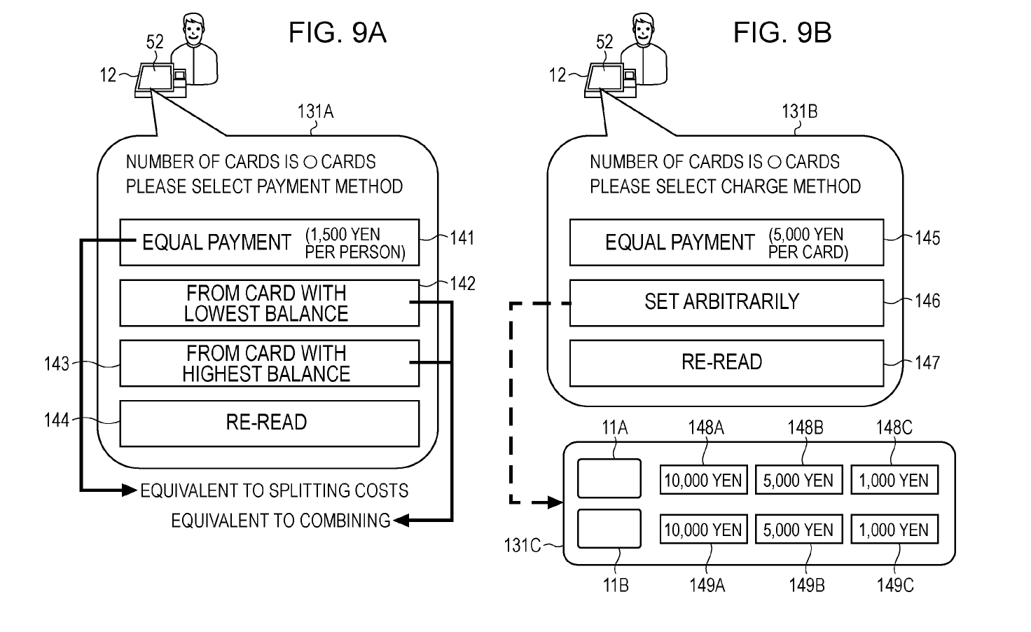

On the other hand, in a case where a plurality of the IC cards 11 are placed, since a payment selection screen 131 of FIG. 9 is display in the display section 52 of the POS terminal device 12, the store personnel communicates “please select payment or charge method from the payment selection screen” with regard to the customer (step S25).

FIG. 9 is a diagram illustrating an example of the payment selection screen 131.

As shown in A of FIG. 9, in a case of paying using the IC card 11, buttons 141 to 144 are displayed in a payment selection screen 131A which is displayed in the display section 52.

The button 141 is selected in a case of paying using a plurality of the IC cards 11 where the amount to be paid is split. For example, since it is 1,500 yen per person when splitting the costs between two people in a case where the amount to be paid is 3,000 yen, this information is also displayed in the button 141.

The button 142 and the button 143 are selected in a case of paying the amount to be paid by combining the electronic money of the plurality of IC cards 11. In addition, the button 142 is selected in a case where there is to be a deduction where the IC card 11 with the lowest balance of electronic money is to be given priority, and the button 143 is selected in a case where there is to be a deduction where the IC card 11 with the highest balance of electronic money is to be given priority out of the plurality of IC cards 11.

The button 144 is selected in a case where the IC cards 11 are to be re-read. For example, the button 144 is selected in a case where the number of IC cards 11 which have been detected is different from the number which is actually placed and the reading of the IC cards 11 is performed again.

As shown in B of FIG. 9, in a case of charging using the IC card 11, buttons 145 to 147 are displayed in a payment selection screen 131B which is displayed in the display section 52.

The button 145 and the button 146 are selected in a case of performing charging with regard to the IC cards 11. In addition, the button 145 is selected in a case where the charging amount is to be divided equally with regard to the plurality of IC cards 11, and the button 146 is set in a case where the charge amount is to be arbitrarily set.

For example, in a case where the charge amount is 10,000 yen, since 5,000 yen is charged with regard to each of the IC cards 11 when the IC card 11A and the IC card 11B are charged, this information is also displayed in button 145. In addition, in the case where the button 146 is selected, a charge amount setting screen 131C is displayed in the display section 52 for arbitrarily setting the charge amount with regard to the customer. For example, buttons 148A to 148C for setting the charge amount to the IC card 11A and buttons 149A to 149C for setting the charge amount to the IC card 11B are displayed in the charge amount setting screen 131C.

The button 147 is selected in a case where the IC cards 11 are to be re-read in the same manner as the button 144 of FIG. 9.

Returning to the flowchart of FIG. 8, the customer selects the payment or charging method from the payment selection screen 131 of FIG. 9 according to the instruction from the store personnel (step S13). After this, a payment process or the like with regard to the plurality of IC cards 11 which are placed at the same time is performed using the POS terminal device 12 (the details will be described later). Then, the store personnel communicate “payment or charging is complete” with regard to the customer in a case where the payment process is completed (step S26).

The transaction between the customer and the store personnel during payment is performed in this manner.

As above, it is possible to provide various services in the case where the plurality of IC cards 11 are placed in the IC card payment system 1 such as a service of splitting the costs or combining when paying and a service of charging together described above.

### [Flow of IC Card Payment Process]

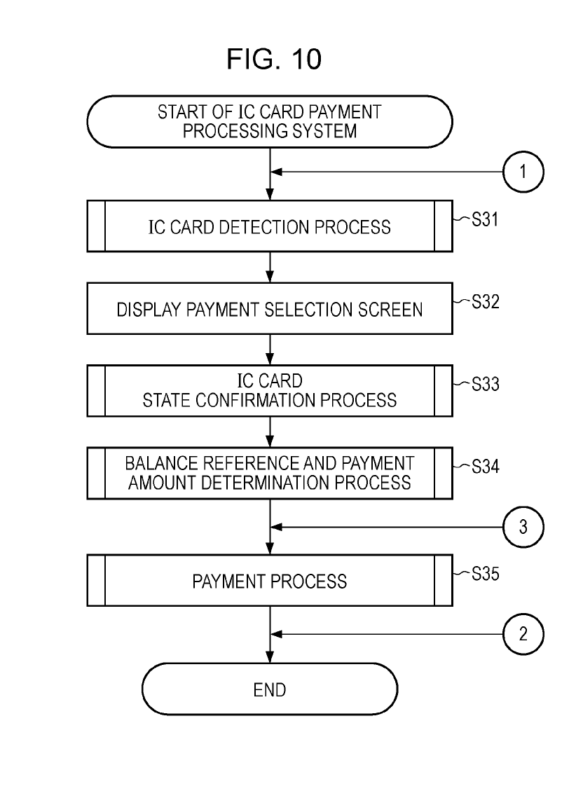

Next, a specific flow of a service which is provided by the IC card payment system 1 will be described with reference to FIGS. 10 to 21.

First, an IC card payment process which is performed by the control section 51 or the control section 71 executing the IC card payment control program 101 will be described with reference to the flowchart of FIG. 10.

In step S31, the IC card detection section 111 performs an IC card detection process. In the IC card detection process, polling is performed and the IC cards 11 are detected in a case where the plurality of IC cards 11 is placed by the customer.

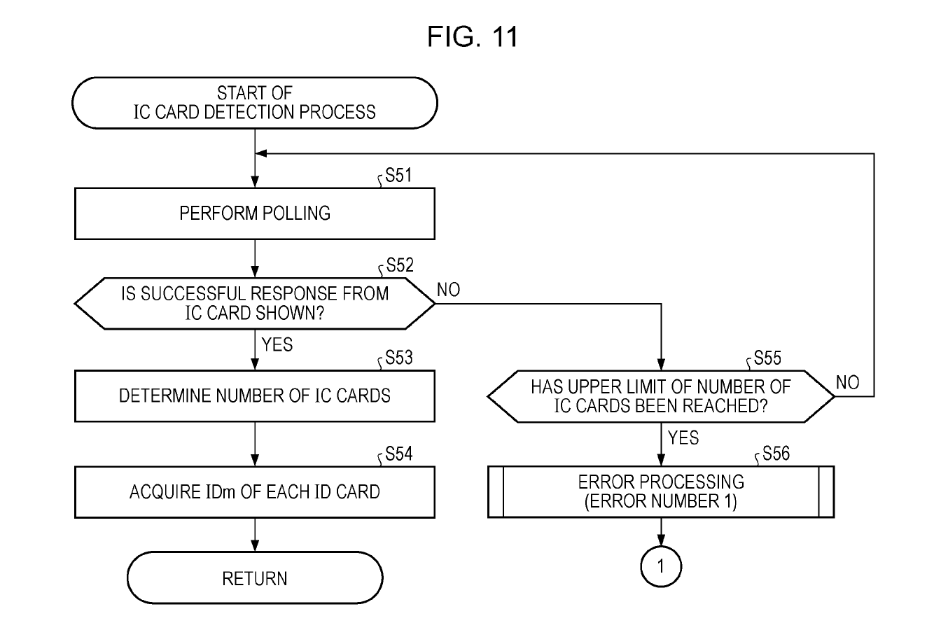

Here, the details of the IC card detection process will be described later with reference to the flowchart of FIG. 11.

When the IC cards 11 are detected, the screen display control section 112 displays the payment selection screen 131 of FIG. 9 on the display section 52 in step S32. Then, the process proceeds to step S33 in a case where the payment or charging method of the payment selection screen is selected by the customer.

In step S33, the IC card state confirmation section 113 performs an IC card state confirmation process. In the IC card state confirmation process, it is determined whether or not there is a state where the plurality of IC cards 11 which have been detected are able to be used.

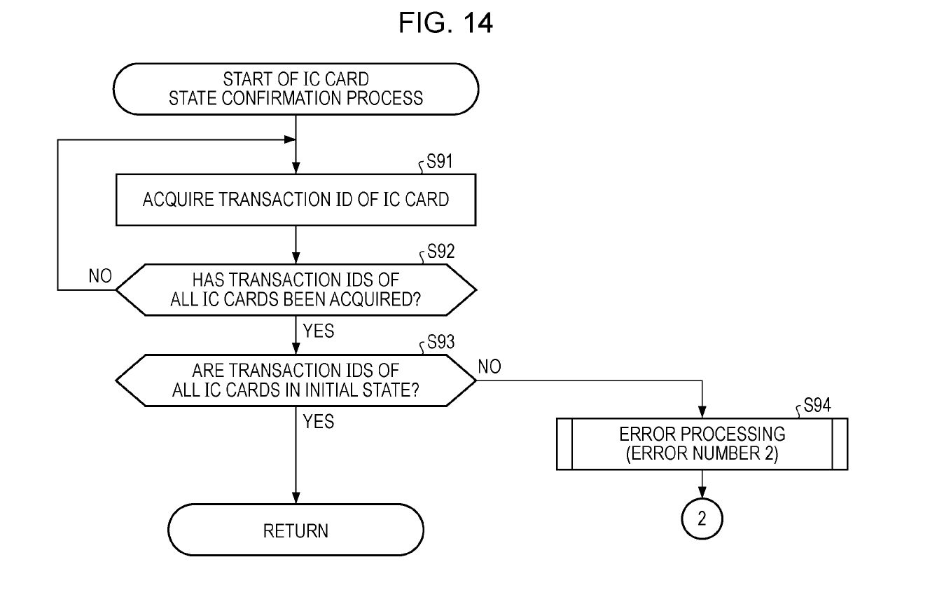

Here, the details of the IC card state confirmation process will be described later with reference to the flowchart of FIG. 14.

When the confirmation of the IC card 11 state is complete, the balance reference and payment amount determination section 114 performs a balance reference and payment amount determination process in step S34. In the balance reference and payment amount determination process, the balance of each of the IC cards 11 and the payment ability are checked, and it is determined whether or not payment using the IC cards 11 which have been detected is possible.

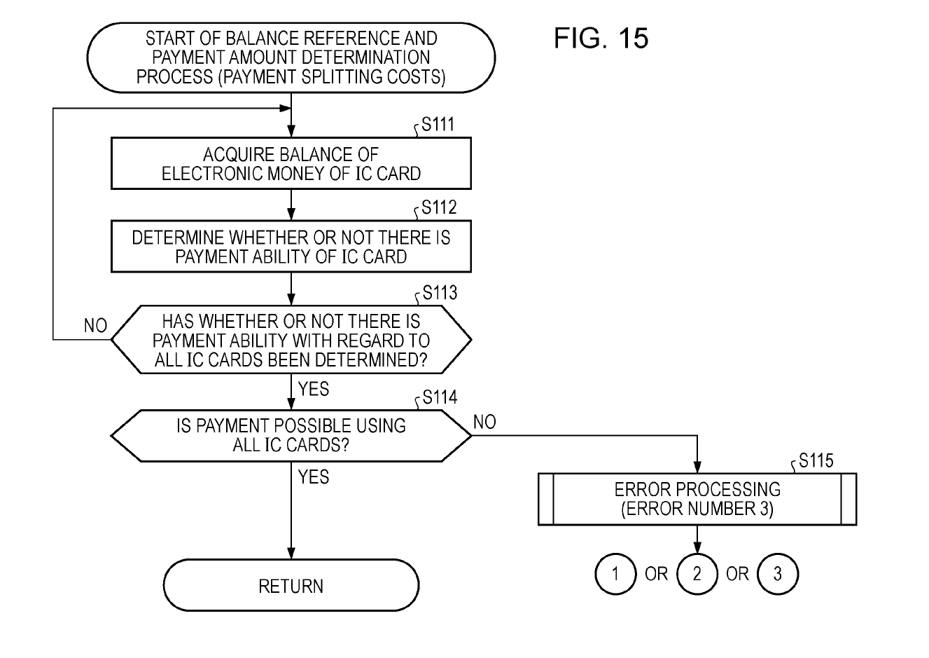

Here, the details of the balance reference and payment amount determination process will be described later with reference to the flowcharts of FIGS. 15, 17, and 18.

When the balances of electronic money of each of the IC cards 11 is referenced and the payment process is determined, the payment section 115 performs a payment process with regard to each of the IC cards 11 in step S35. In the payment process, a process is performed such as a monetary amount being deducted according to the payment amount with regard to each of the IC cards 11.

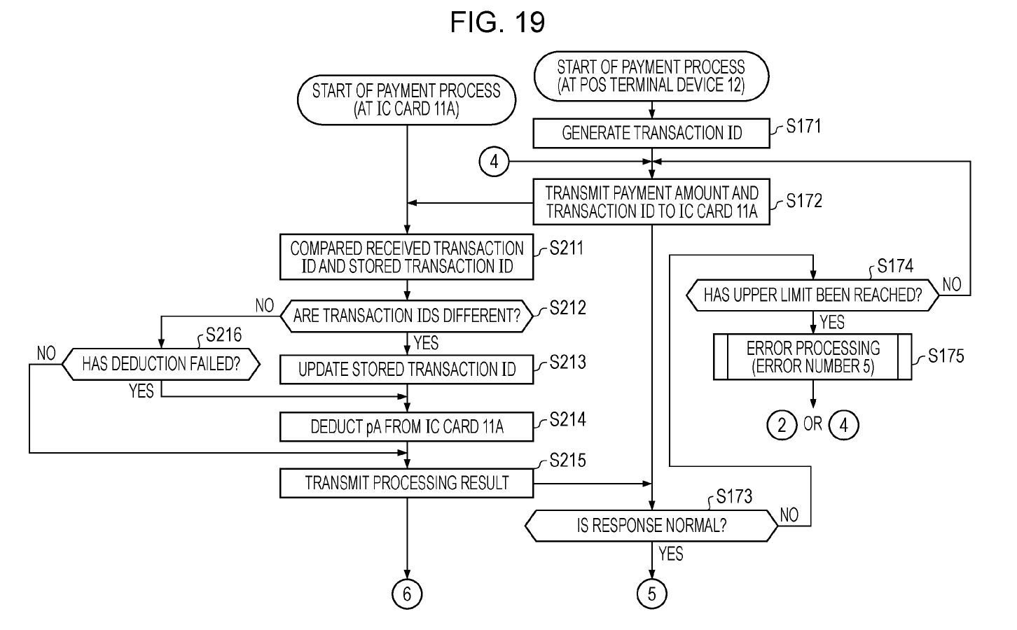

Here, the details of the payment process will be described later with reference to the flowcharts of FIGS. 19 to 21.

When the payment process is complete, the IC card payment process is complete.

As above, in the IC card payment process, the plurality of the IC cards 11 which are placed by the customer are detected, whether or not there is a state where the IC card 11 which are detected are able to be used, and the balances and the payment ability of the IC cards 11 which are in a state where usage is possible are checked. Then, the payment process is performed such as a monetary amount being deducted according to the payment amount with regard to the IC cards 11 where payment is possible.

### [Flow of IC Card Detection Process]

Next, the details of the IC card detection process which corresponds to step S31 of FIG. 10 will be described with reference to the flowchart of FIG. 11.

In step S51, the IC card detection section 111 performs polling and it is determined whether or not the response from the IC cards 11 is shown as a success (step S52).

As a response from the IC cards 11, there are cases where a response of success or failure of the polling is returned or cases where a response is not returned. Accordingly, in the determination process of step S52, it is determined whether or not there is one or more of the IC cards 11 which responded when the result is successful.

In step S52, in a case where not any of the IC card 11 responded when the result is successful, the process proceeds to step S55. In step S55, the IC card detection section 111 determines whether or not the number of times where polling has been tried has reached a predetermined upper limit.

In the case where it is determined in step S55 that the number of times where polling has been tried has not reached the predetermined upper limit, the process returns to step S51 and the polling is tried again.

On the other hand, even if the number of times where polling has been tried has reached the predetermined upper limit, the process proceeds to step S56 in a case where there is not a successful response from the IC card 11 (“Yes” in step S55). In step S56, the error processing section 116 performs error processing for an error number 1.

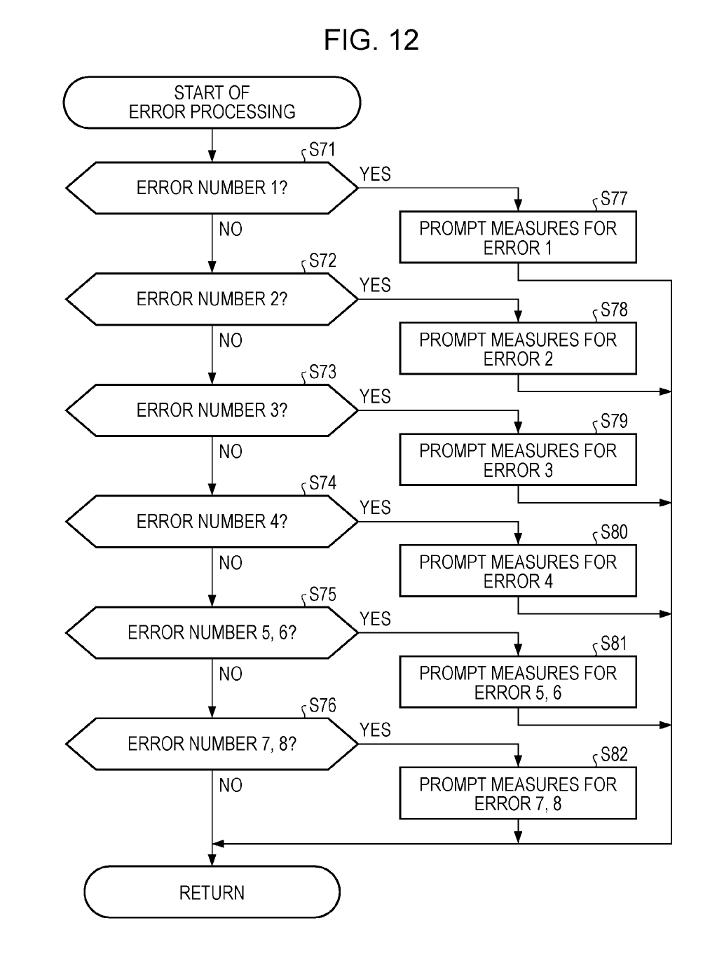

Here, the details of the error processing which corresponds to step S56 will be described with reference to the flowchart of FIG. 12.

The error processing section 116 determines either of the error numbers 1 to 8 in steps S71 to S76. In the case here, since there is the error number 1 (“Yes” in step S71), the process progresses to step S77.

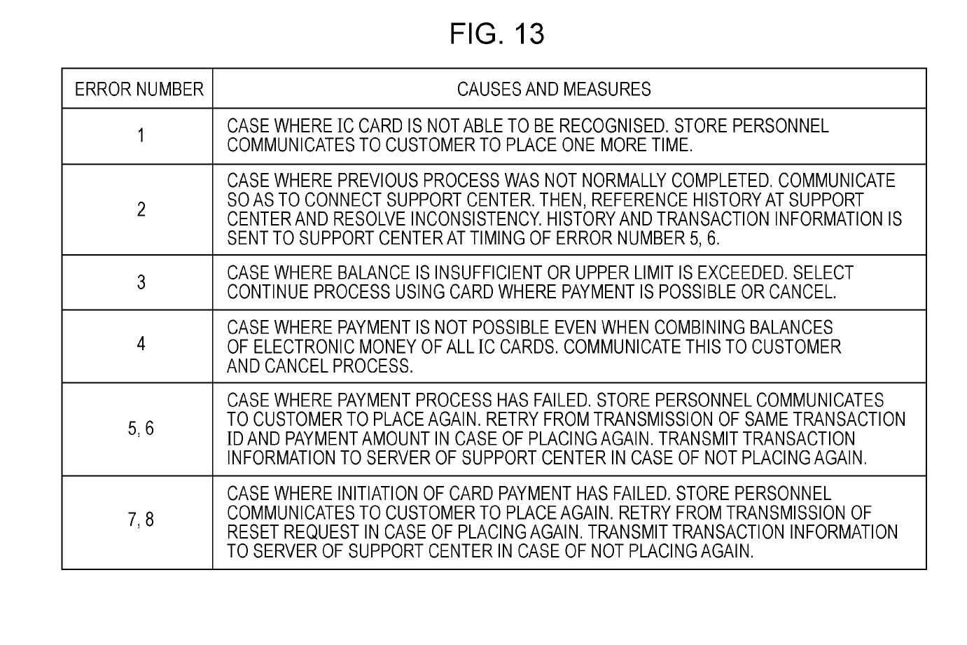

In step S77, the error processing section 116 prompts measures to error number 1. As shown in FIG. 13, as the measure for the error number 1, since there is a case where the IC card 11 is not able to be recognized, for example, to place the IC card 11 one more time is communicated to the customer with regard to the store personnel by displaying an error message.

When the process of step S77 is completed, the process returns to the flowchart of FIG. 11 and the process from step S56 and beyond is performed. Then, the process returns to step S31 of FIG. 10 and the IC card detection process is performed again.

On the other hand, in a case where it is determined that there was a successful response from the IC card 11 in step S52, the process proceeds to step S53. In step S53, the IC card detection section 111 determines the number of IC cards 11 which are detected.

In step S54, the IC card detection section 111 acquires an identifier (referred to below as IDm) for uniquely identifying each of the IC cards 11 which is acquired using proximity communication with the IC cards 11. Here, in the process and beyond, the IDm is used for identifying each of the IC cards 11 in the case where proximity communication with the plurality of IC cards 11 which have been detected is performed.

When the IDm of each of the IC cards 11 are acquired, the process returns to the step S31 of FIG. 10 and the process of step S31 and beyond is executed.

As above, in the IC card detection process, polling is perform, the IC card 11 which is placed by the customer is detected, and the number of the IC cards 11 which are detected and the IDm of each of the IC cards 11 are acquired.

### [Flow of IC Card State Confirmation Process]

Next, the details of the IC card state confirmation process which corresponds to step S33 of FIG. 10 will be described with reference to the flowchart of FIG. 14.

In step S91, the IC card state confirmation section 113 acquires the transaction IDs of the IC cards 11 which are detected by the IC card detection process.

In step S92, the IC card state confirmation section 113 determines whether or not the transaction IDs of all of the IC cards 11 which have been detected are acquired.

In a case where it is determined in step S92 that the transaction IDs of all of the IC cards 11 which have been detected have been not acquired, the process returns to step S91 and the transaction IDs are acquired from the IC cards 11 where the transaction IDs have not been acquired.

The processes of step S91 and S92 are repeated and the process proceeds to step S93 in a case where it is determined that the transaction IDs in all of the IC cards have been acquired, the process proceeds to step S93.

In step S93, the IC card state confirmation section 113 determines whether or not the transaction IDs of all of the IC cards 11 which have been acquired is in an initial state. For example, in a case where the transaction ID==0, it is determined that there is an initial state.

In a case where it is determined in S93 that the transaction IDs of all of the IC cards 11 which have been acquired is not in an initial state, the process proceeds to step S94. In step S94, the error processing section 116 performs the error processing of the error number 2.

Here, the details of the error processing which corresponds to step S94 will be described with reference to the flowchart of FIG. 12 described above.

Either of the error numbers 1 to 8 is determined in steps S71 to S76, and in the case here, since there is the error number 2 (“Yes” in step S72), the process progresses to step S78.

In step S78, the error processing section 116 prompts the measures of the error number 2. As is shown in FIG. 13, as the measure of the error number 2, since there is a case where the previous process is not normally completed, for example, the store personnel communicates so as to inquire to the support center with regard to the customer by displaying an error message. In this case, by information which relates to the IC card 11 which is used by the customer referencing the history and the transaction information which are recorded in the server 13 in the support center, the inconsistency is resolved. Here, the history and transaction information is transmitted to the server 13 at a timing where the process of the error number 5, 6 which are described later is performed.

When the process of step S78 is complete, the process returns to the flowchart of FIG. 14 and the process from step S94 and beyond is performed. In this case, the continuation of the payment which uses the IC card 11 is not able to be carried out, the process returns to the flowchart of FIG. 10 and the IC card payment process is complete.

On the other hand, in a case where it is determined in step S93 that the transaction IDs of all of the IC cards 11 which have been acquired is in an initial state, the process returns to the flowchart of FIG. 10 and the process from step S33 and beyond are executed.

As above, in the IC card state confirmation process, the transaction IDs are acquired from the IC cards 11 which have been detected, it is determined whether or not the transaction IDs which have been acquired are in an initial state, and the state of the IC card 11 is confirmed.

### [Flow of Balance Reference and Payment Amount Determination Process (Payment: Splitting)]

Next, the details of the balance reference and payment amount determination process which corresponds to step S34 of FIG. 10 will be described with reference to the flowchart of FIG. 15.

In step S111, the balance reference and payment amount determination section 114 acquires the balances of the electronic money from the IC cards 11.

In step S112, the balance reference and payment amount determination section 114 determines the payment ability of each of the IC cards 11 based on the number of IC cards 11 which have been detected and the balances which are acquired from each of the IC cards 11.

In a case of paying by splitting the amount to be paid, for example, the amount to be paid per single IC card 11 is x/n in a case where the number of IC cards 11 is set as n and the amount to be paid is set as x. Accordingly, the payment ability of the IC cards 11 is determined by determining whether or not the balance of each of the IC cards exceeds the amount to be paid which has been split. Specifically, there is a condition where the following equation (1) is satisfied.

Balance≧x/n (1)

In step S113, the balance reference and payment amount determination section 114 determines whether or not the payment ability with regard to all of the IC cards 11 has been determined.

In a case where it is determined in step S113 that the payment ability with regard to all of the IC cards 11 has not been determined, the process returns to step S111 and the balance is acquired from the IC cards 11 where the payment ability has not yet been determined and the payment ability is determined. In a case where it is determined that the payment ability with regard to all of the IC cards 11 has been determined (“Yes” in step S113), the process proceeds to step S114.

In step S114, the balance reference and payment amount determination section 114 determines whether or not payment is possible for all of the IC cards 11 where the payment ability has been determined.

In a case where it is determined in step S114 that it is not the case that payment is possible for all of the IC cards 11, the process proceeds to step S115. In step S115, the error processing section 116 performs the error processing for the error number 3.

Here, the details of the error processing which corresponds to step S115 will be described with reference to the flowchart of FIG. 12 described above.

Either of the error numbers 1 to 8 is determined in steps S71 to S76, and in the case here, since there is the error number 3 (“Yes” in step S73), the process progresses to step S79.

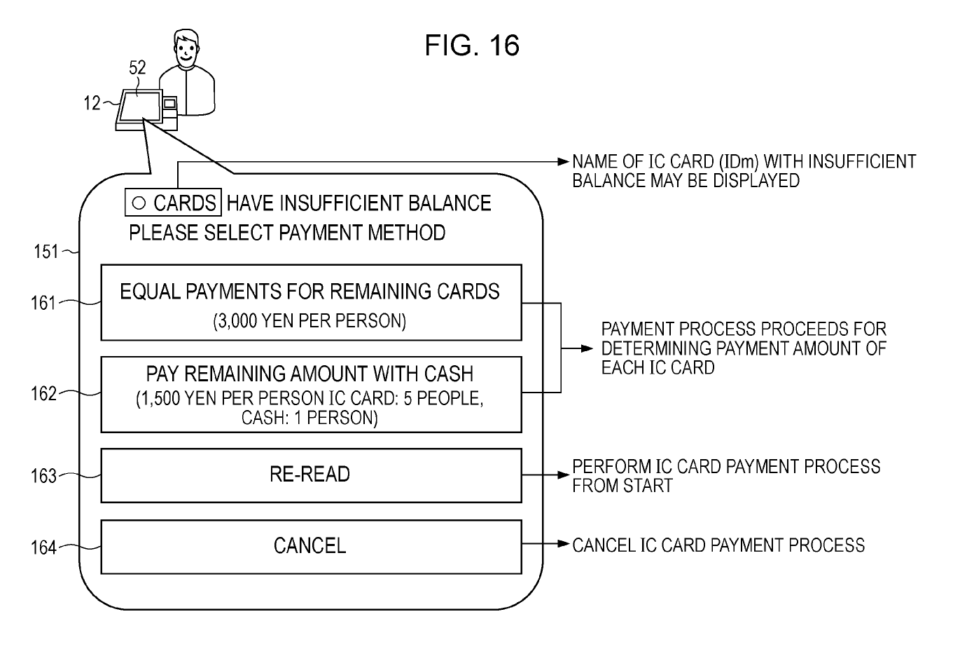

In step S79, the error processing section 116 prompts the measure for the error number 3. As shown in FIG. 13, as the measure for the error number 3, since there is a case where the balance is insufficient or the upper limit of the charge has been exceeded, continuation of the process with the IC cards 11 where payment is possible or the cancellation of the payment is made to be selected using a payment reselection screen 151 of FIG. 16 being displayed on the display section 52.

FIG. 16 is a diagram illustrating an example of the payment reselection screen 151.

As shown in FIG. 16, in a case where there is no ability to pay in the IC card 11, buttons 161 to 164 and the number of IC cards 11 where the balance is insufficient is displayed in the payment reselection screen 151 which is displayed on the display section 52. Here, instead of the number of IC cards 11, the name (for example, IDm) of the IC cards 11 with insufficient balances may be displayed.

The button 161 is selected in a case of continuing the payment using the other IC cards 11 excluding the IC cards 11 where the balance is insufficient. For example, in a case where there is a desire to split the costs of 6,000 yen between three people but the balance of the IC card 11 of one person is insufficient, the costs are split between two people and the amount to be paid per person changes from 2,000 yen to 3,000 yen. Of course, in this case, the payment amount per person increases.

The button 162 is selected in a case where the payment amount which was planned to be paid using the IC card 11 where the balance is insufficient is paid in cash or the payment amount which was planned is deducted from another IC card 11. For example, in a case where there is a desire to split the costs of 9,000 yen between six people but the balance of the IC card 11 of one person is insufficient, 1,500 yen which is the payment amount of one person is paid using cash and not the IC card 11. In this case, the payment amount per person does not increase.

In a case where the button 161 and the button 162 are selected, the process proceeds to step S35 (the payment process) of FIG. 10 since the payment amount of each IC card has been determined.

The button 163 is selected in a case where the IC cards 11 are to be re-read. In this case, the process returns to step S31 (the IC card detection process) of FIG. 10 and the IC card payment process is performed from the start.

The button 164 is selected in a case where the payment using the IC cards 11 is to be cancelled. In this case, the process returns to the flowchart of FIG. 10 and the IC card payment process is completed.

Returning to the flowchart of FIG. 15, on the other hand, in a case where it is determined in step S114 that payment is possible for all of the IC cards 11, the process returns to the flowchart of FIG. 10 and the process from step S34 and beyond is executed.

As above, in the balance reference and payment amount determination process (payment: splitting), the balances are acquired from the IC cards 11 which are detected, and the monetary amount is determined as the payment amount for each of the IC cards 11 in a case where the balances exceed the monetary amount for splitting the costs which is acquired by dividing the amount to be paid by the number of IC cards 11.

### [Flow of Balance Reference and Payment Amount Determination Process (Charge)]

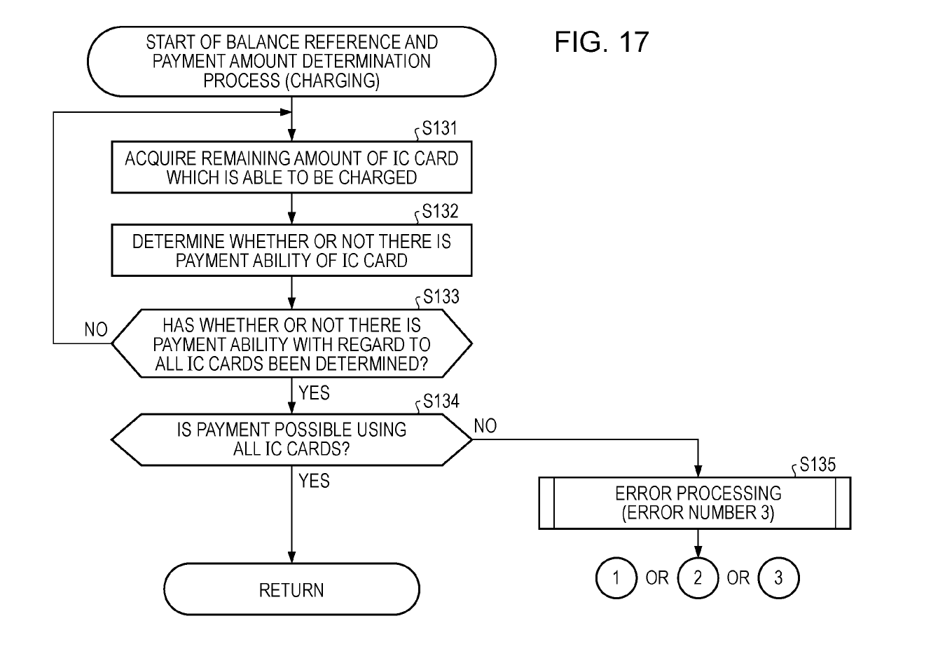

In the flowchart of FIG. 15, a process in a case of splitting the costs out of paying has been described as an example of the balance reference and payment amount determination process, and next, the balance reference and payment amount determination process in the case of charging will be described with reference to the flowchart of FIG. 17.

In step S131, the balance reference and payment amount determination section 114 acquires the information which relates to the remaining monetary amount which is able to be charged with electronic money in the IC card 11 (referred to below as amount where remaining charge is possible) from the IC card 11.

In step S132, the balance reference and payment amount determination section 114 determines the payment ability of each of the IC cards 11 based on the number of IC cards 11 which have been detected and the amount where remaining charge is possible which is acquired from each of the IC cards 11.

In a case of charging, for example, the charge amount per single IC card 11 is x/n in a case where the number of IC cards 11 is set as n and the charge amount is set as x. Accordingly, the payment ability of the IC cards 11 is determined by determining whether or not the amount where remaining charge is possible with regard to each of the IC cards 11 exceeds the charge amount per card. Specifically, there is a condition where the following equation (2) is satisfied.

Amount where remaining charge is possible≧x/n (2)

Here, in equation (2), the amount where remaining charge is possible is a monetary amount which is acquired by subtracting the balances from the upper limit amount for charging.

In step S133, it is determined whether or not the payment ability with regard to all of the IC cards 11 has been determined in the same manner as step S113 of FIG. 15.

In a case where it is determined in step S133 that the payment ability with regard to all of the IC cards 11 has not been determined, the process returns to step S131 and the amount where remaining charge is possible is acquired from the IC cards 11 where the payment ability has not yet been determined and the payment ability is determined. In a case where it is determined that the payment ability with regard to all of the IC cards 11 has been determined (“Yes” in step S133), the process proceeds to step S134.

In step S134, it is determined whether or not payment is possible for all of the IC cards 11 where the payment ability has been determined in the same manner as the step S114 of FIG. 15. Then, in a case where it is determined in step S134 that it is not the case that payment is possible for all of the IC cards 11, the error processing for the error number 3 is performed. Since the error processing is the same as step S115 of FIG. 15, the description thereof is omitted.

On the other hand, in a case where it is determined in step S134 that payment is possible for all of the IC cards 11, the process returns to the flowchart of FIG. 10 and the process from step S34 and beyond is executed.

As above, in the balance reference and payment amount determination process (charging), the amounts where remaining charge is possible are acquired from the IC cards 11 which are detected, and the monetary amount is determined as the charge amount for each of the IC cards 11 in a case where the amounts where remaining charge is possible exceed the monetary amount which is acquired by dividing the charge amount by the number of IC cards 11.

### [Flow of Balance Reference and Payment Amount Determination Process (Payment: Combining)]

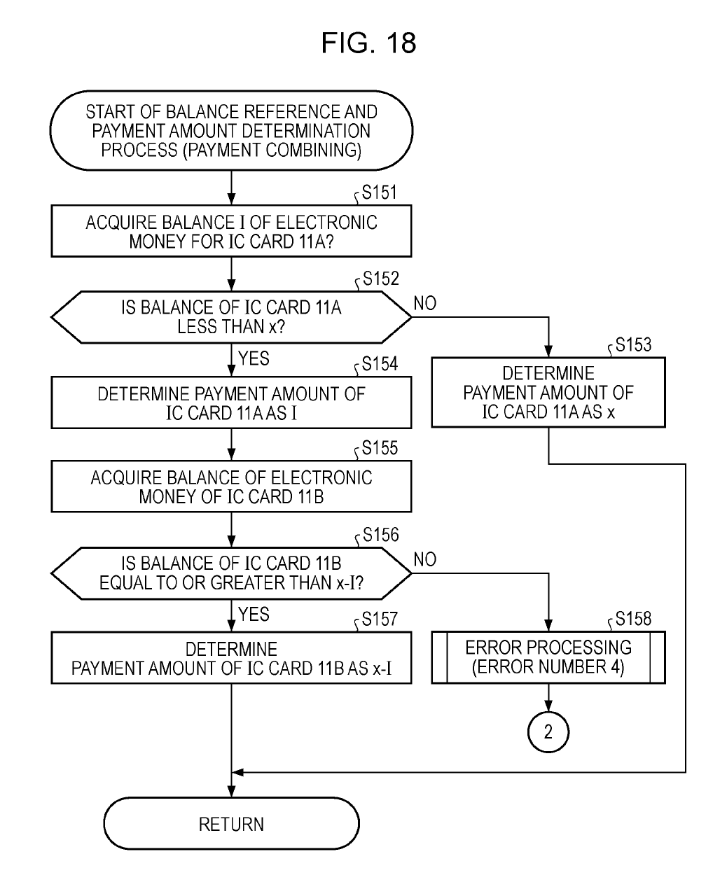

In the flowchart of FIG. 15, a process in a case of splitting the costs out of paying has been described as an example of the balance reference and payment amount determination process, and next, the balance reference and payment amount determination process (payment: combining) will be described with reference to the flowchart of FIG. 18.

Here, in order for the description to be specific in the description of FIG. 18, an example will be described where the electronic money in two IC cards of the IC card 11A and the IC card 11B are combined. In addition, the balance of the IC card 11A is lower than the balance of the IC card 11B. In addition, the balance of the IC card 11A is set as I and the amount to be paid is set as x.

In step S151, the balance reference and payment amount determination section 114 acquires the balance I of the electronic money from the IC card 11A.

In step S152, the balance reference and payment amount determination section 114 determines whether or not the balance I of the IC card 11A which has been acquired is lower than the amount to be paid x.

In a case where it is determined in step S152 that the balance I of the IC card 11A which has been acquired is higher than the amount to be paid x, the process proceeds to step S153. In step S153, the balance reference and payment amount determination section 114 determines the payment amount of the IC card 11A as x. In this case, the paying is performed with only the electronic money on the IC card 11A.

On the other hand, in a case where it is determined in step S152 that the balance I of the IC card 11A which has been acquired is lower than the amount to be paid x, the process proceeds to step S154. In step S154, the balance reference and payment amount determination section 114 determines the payment amount of the IC card 11A as I.

In step S155, the balance reference and payment amount determination section 114 acquires the balance of the electronic money on the IC card 11B.

In step S156, it is determined whether or not the balance on the IC card 11B which has been acquired is higher than the monetary amount (x−I) which is the balance (I) on the IC card 11A subtracted from amount to the paid (x).

In a case where it is determined in step S156 that the balance on the IC card 11B is higher than the monetary amount (x−I), the process proceeds to step S157. In step S157, the balance reference and payment amount determination section 114 determines that the payment amount of the IC card 11B is x−I. Due to this, out of the amount to be paid x, the monetary amount I is allocated as the payment amount of the IC card 11A and the monetary amount x−I is allocated as the payment amount of the IC card 11B.

On the other hand, in a case where it is determined in step S156 that the balance on the IC card 11B is lower than the monetary amount (x−I), the process proceeds to step s158. In step S158, the error processing section 116 performs error processing of the error number 4.

Here, the details of the error processing which correspond to step S158 will be described with reference to the flowchart of FIG. 12.

The error processing section 116 determines either of the error numbers 1 to 8 in steps S71 to S76. In the case here, since there is the error number 4 (“Yes” in step S74), the process progresses to step S80.

In step S80, the error processing section 116 prompts measures to error number 4. As shown in FIG. 13, since there is not payment ability even if the balances of the electronic money of all of the IC cards 11 are combined, for example, that the process is cancelled since there is not payment ability is communicated to the customer with regard to the store personnel by an error message being displayed.

When the error processing is complete, the process returns to the flowchart of FIG. 18 and the process from step S158 and beyond is performed. Then, the process returns to the flowchart of FIG. 10 and the IC card payment process is complete.

As above, in the balance reference and payment amount determination process (payment: combining), the payment amounts are determined according to the balances of the electronic money on each of the IC cards 11 in a case where the monetary amount, which is acquired by the balances of the electronic money acquired for each of the IC cards 11 which have been detected being combined, exceeds the amount to be paid.

Here, in order for the description to be specific, the two IC cards 11 have been described as an example, but the content of a process is basically the same for three IC cards 11 or more.

Above, as specific examples of the balance reference and payment amount determination process, the three examples of payment: splitting, charging, and payment: combining have been described.

### [Payment Process]

Next, the details of the payment process which corresponds to step S35 of FIG. 10 will be described with reference to the flowcharts of FIGS. 19 to 21.

Here, in order for the description to be specific in the description of FIGS. 19 to 21, along with the payment process which is performed using the POS terminal device 12, the payment process which is performed using the two IC cards of the IC card 11A and the IC card 11B will be described. In addition, the payment amount of the IC card 11A is set as pA and the payment amount of the IC card 11B is set as pB as determined using the balance reference and payment amount determination process described above.

In step S171, the payment section 115 of the POS terminal device 12 generates the transaction ID. The transaction ID is a unique value.

In step S172, the payment section 115 transmits the payment amount pA which is determined using the balance reference and payment amount determination process and the transaction ID which has been generated to the IC card 11A.

When the payment amount pA and the transaction ID are transmitted from the POS terminal device 12, this information is received in the IC card 11A. Then, in step S211, the control section 34 of the IC card 11A compares the transaction ID which has been received and a transaction ID which is held.

In step S212, in a case where the transaction IDs which have been compared are different, the process proceeds to step S213. In step S213, the control section 34 updates the transaction ID which is held to the transaction ID which has been received.

In step S214, the control section 34 deducts the payment amount pA from the balance of the electronic money which is recorded in the recording section 37, and the processing result is transmitted to the POS terminal device 12 (step S215).

On the other hand, in step S212, in a case where the transaction IDs which have been compared are the same, the process proceeds to step S216 since the previous process was terminated at an intermediate point. In step S216, the control section 34 determines the whether or not the deduction of the payment amount pA has failed by referencing the balance of the electronic money which is recorded in the recording section 37.

In a case where it is determined in step S216 that the deduction of the payment amount pA has failed, the process proceeds to step S214 since the deduction is attempted again. In step S214, the control section 34 deducts the payment amount pA from the balance of the electronic money and the processing result is transmitted to the POS terminal device 12 (step S215).

On the other hand, in a case where it is determined in step S216 that the deduction of the payment amount pA was successful, the process proceeds to S215 since there is a problem in the transmission of the processing result. In step S215, the control section 34 transmits the processing result to the POS terminal device 12.

When the processing result from the IC card 11A is transmitted, the processing result is received in the POS terminal device 12. Then, in step S173, it is determined whether the processing result which was received as a response is normal.

In a case where it is determined in step S173 that the response is abnormal, the process proceeds to step S174. In step S174, the payment section 115 determines whether or not the number of times of processing has reached an upper limit of the number of times. In a case where it is determined in step S174 that the number of times of processing has not reached an upper limit of the number of times, the process returns to step S172. Then, the process described above is repeated until a normal response is received (“Yes” in step S173) or the upper limit of the number of times is reached (“Yes” in step S174).

In a case where the upper limit of the number of times is reached before the normal response is returned, the process proceeds to step S175. In step S175, the error processing section 116 performs the error processing for the error number 5.

Here, the details of the error processing which corresponds to step S175 will be described with reference to the flowchart of FIG. 12 described above.

Either of the error numbers 1 to 8 is determined in steps S71 to S76, and in the case here, since there is the error number 5 (“Yes” in step S75), the process progresses to step S81.

In step S81, the error processing section 116 prompts the measure for the error number 5. As shown in FIG. 13, as the measure for the error number 5, since there is a case where the payment process has failed, for example, that the customer places the IC card 11A again is communicated to the customer with regard to the store personnel by an error message being displayed. In a case where the IC card 11A is placed again by the customer, there is an attempt again from the transmission of the same transaction ID and the payment amount pA (step S172).

On the other hand, in a case where the IC card 11A is not placed, the error processing section 116 transmits the transaction information to the server 13 of the support center by controlling the communication section 53. The transaction information is used in the error processing of the error number 2 as described above. Here, in this case, after this, the process returns to the flowchart of FIG. 10 and the IC card payment process is completed.

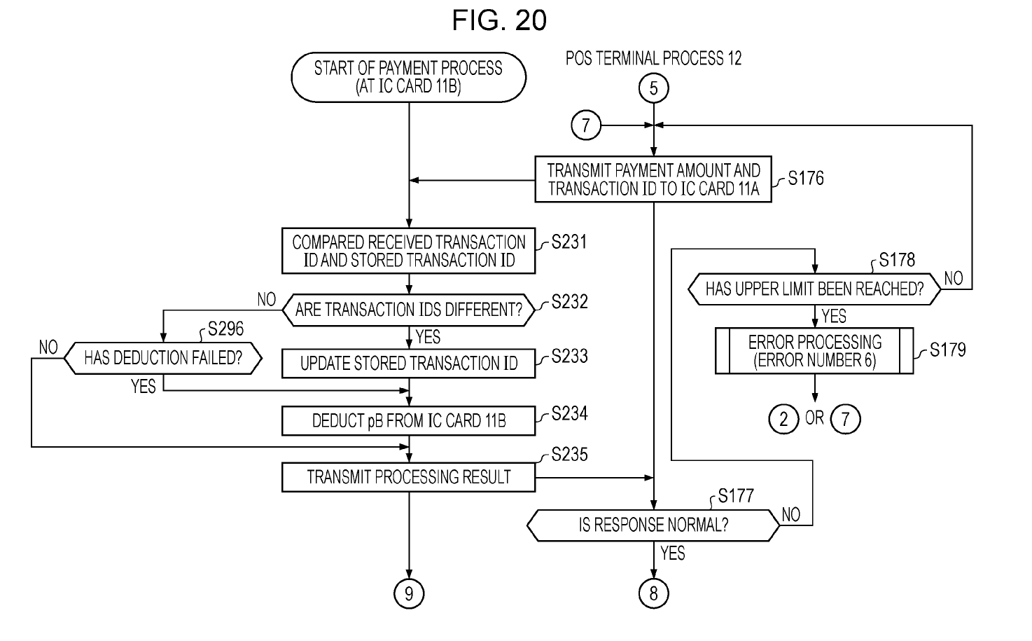

Returning to the flowchart of FIG. 19, on the other hand, in a case where it is determined in step S173 that the response from the IC card 11A is normal, the process proceeds to step S176 of FIG. 20.

In step S176, the payment section 115 of the POS terminal device 12 transmits the payment amount pB and the transaction ID with regard to the IC card 11B in the same manner as the IC card 11A.

When the payment amount pB and the transaction ID are transmitted from the POS terminal device 12, this information is received in the IC card 11B and the payment process of step S231 to S235 is performed. Then, in steps S231 to S235, the payment amount pB is deducted from the balance of the electronic money of the IC card 11B, and the processing result is transmitted to the POS terminal device 12 in the same manner as steps 211 to 215 of FIG. 19.

When the processing result is transmitted from the IC card 11B, the processing result is received in the POS terminal device 12. Then, in the same manner as the steps S173 to S175 of FIG. 19, in the steps S177 to S179, the determination process of whether or not the response is normal and the determination process of whether or not the upper limit of the number of times is reached are performed, and the error processing of the error number 6 is performed in a case where the upper limit of the number of times is reached. Since the error processing is the same as the step S175 of FIG. 19, the description thereof is omitted.

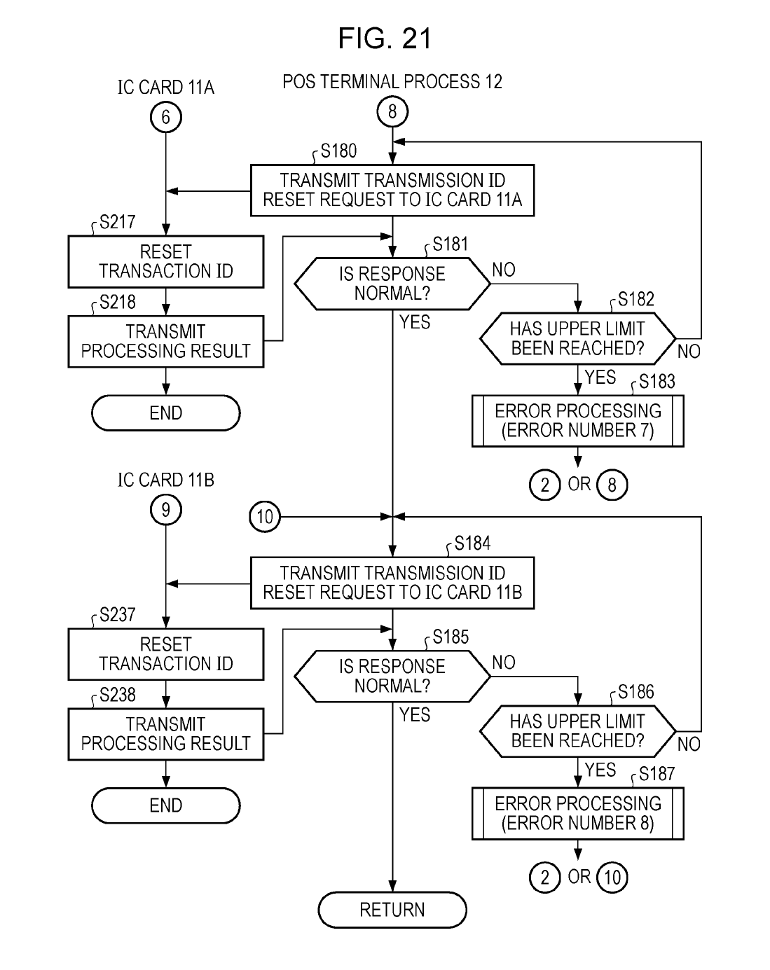

On the other hand, in a case where it is determined in step S177 that the response from the IC card 11B is normal, the process proceeds to step S180 of FIG. 21.

In step S180, the payment section 115 of the POS terminal device 12 transmits a transaction ID reset request to the IC card 11A.

When the reset request is transmitted from the POS terminal device 12, the reset request is received by the IC card 11A. Then, in step S217, the control section 34 of the IC card 11A resets the transaction ID according to the reset request. For example, the transaction ID is updated to zero. In step S218, the control section 34 transmits the reset processing result to the POS terminal device 12.

When the processing result is transmitted from the IC card 11A, the processing result is received in the POS terminal device 12. Then, in step S181, it is determined whether or not the processing result which was received as a response is normal.

In a case where it is determined in step S181 that the response is not normal, the process proceeds to step S182. In step S182, the payment section 115 determines whether or not the number of times of processing has reached an upper limit of the number of times. In a case where it is determined in step S182 that the number of times of processing has not reached an upper limit of the number of times, the process returns to step S180. Then, the process described above is repeated until a normal response is received (“Yes” in step S181) or the upper limit of the number of times is reached (“Yes” in step S182).

In a case where the upper limit of the number of times is reached before the normal response is returned, the process proceeds to step S183. In step S183, the error processing section 116 performs the error processing for the error number 7.

Here, the details of the error processing which corresponds to step S183 will be described with reference to the flowchart of FIG. 12 described above.

Either of the error numbers 1 to 8 is determined in steps S71 to S76, and in the case here, since there is the error number 7 (“Yes” in step S76), the process progresses to step S82.

In step S82, the error processing section 116 prompts the measure for the error number 7. As shown in FIG. 13, as the measure for the error number 7, since there is a case where the initialization of the card state has failed, for example, that the IC card 11A is to be placed again is communicated to the customer with regard to the store personnel by an error message being displayed. The transmission of the reset request is attempted again in a case where the IC card 11A is placed again (step S180).

On the other hand, in a case where the IC card 11A is not placed, the transaction information is transmitted to the server 13 of the support center. The transaction information is used in the error processing of the error number 2 as described above. Here, in this case, after this, the process returns to the flowchart of FIG. 10 and the IC card payment process is completed.

Returning to the flowchart of FIG. 21, in a case where it is determined in step S181 that the response from the IC card 11A is normal, the process proceeds to step S184. In step S184, the payment section 115 of the POS terminal device 12 transmits the transaction ID reset request with regard to the IC card 11B in the same manner as the IC card 11A.

When the reset request is transmitted from the POS terminal device 12, the rest request is received by the IC card 11B and the payment process of steps S237 and S238 are performed. In steps S237 and 238, the transaction ID is reset and the processing result is transmitted to the POS terminal device 12 in the same manner as step S217 and S218.

When the processing result is transmitted from the IC card 11B, the processing result is received in the POS terminal device 12. Then, in the same manner as steps S181 to S183, in steps S185 to 187, the determination process of whether or not the response is normal and the determination process of whether or not the upper limit of the number of times is reached are performed, and the error processing of the error number 8 is performed in a case where the upper limit of the number of times is reached. Since the error processing is the same as the step S183, the description thereof is omitted.

In a case where it is determined in step S185 that the response from the IC card 11B is normal, the process returns to the flowchart of FIG. 10 and the IC card payment process is terminated.

Here, in the description of FIGS. 19 to 21, the payment process of paying (splitting or combining) has been described and a process of a case where the payment amounts pA and pB are deducted respectively from the IC card 11A and the IC card 11B has been described. On the other hand, the case of charging has not been described, but since the process is the same other than only the payment amounts pA and pB are charged with regard to the IC card 11A and the IC card 11B instead of the deduction in the case of paying, the description thereof is omitted.

In addition, in order for the description to be specific, the example of two of the IC cards 11 has been described, but the content of a process is basically the same for three IC cards 11 or more.

As above, in the payment process, the payment amount which is determined for each of the IC cards 11 is transmitted along with the transaction ID to the IC card 11 which is the target, and the payment is performed for each of the IC cards 11.

In this manner, in the IC card payment system, the plurality of IC cards 11 which are placed by the customer are detected, it is determined whether or not the IC cards 11 which has been detected are in a state where usage is possible, and the balances of the IC cards 11 which are a state where usage is possible and the payment ability are checked. Then, the payment process such as the deduction of the monetary amount according to the payment amount is performed with regard to the IC cards 11 where payment is possible.

Due to this, in a case where the plurality of the IC cards 11 are placed, for example, it is possible to improve the convenience of the service where proximity communication is used since it is possible to provide various services such as splitting or combining when paying and charging.

### 2. Second Embodiment

Here, in the description described above, an example of a payment service which is provided using the IC card payment service 1 has been described, but the present technology is able to be applied to services other than payment. Therefore, next, a data transfer service and a site induction service will be described as examples of a service other than payment.

### [Configuration of IC Card Data Transfer System]

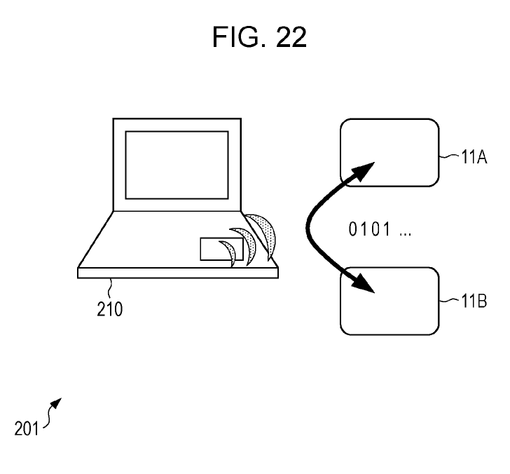

First, a data transfer service will be described with reference to FIGS. 22 to 25.

FIG. 22 is a diagram illustrating a configuration example of an IC card data transfer system where the present technology is applied.

As shown in FIG. 22, an IC card data transfer system 201 is configured from the plurality of IC cards 11 and a personal computer 210.

The personal computer 210 is, for example, disposed in a store and performs a process where data on one of the IC cards 11 out of the plurality of the IC cards 11 which are held by a customer is transferred to another of the IC cards 11. In FIG. 22, the two of the IC card 11A and the IC card 11B are shown as an example of the plurality of IC cards 11.

The IC card data transfer system 201 is configured as above.

### [Configuration of Personal Computer]

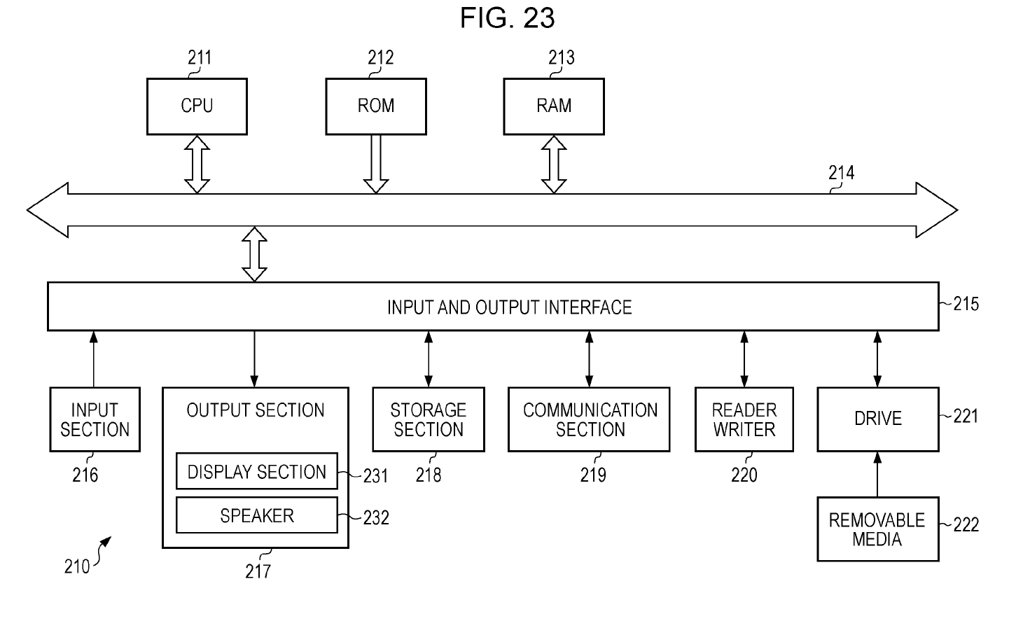

FIG. 23 is a diagram illustrating a configuration of the personal computer 210.

A CPU 211 executes various processes in accordance with a program which is stored in a ROM 212 or a program which is recorded in a recording section 218. In a RAM 213, programs which are executed by the CPU 211, data and the like are appropriately stored. The CPU 211, the ROM 212, and the RAM 213 are connected to each other via a bus 214.

In the CPU 211, an input and output interface 215 is also connected via the bus 214. In the input and output interface 215, an input section 216 which is formed from a keyboard, a mouse, or the like, and an output device 217 which is formed from a display section 231, a speaker 232 and the like are connected. The CPU 211 executes various processes according to an instruction which is input from the input section 216. Then, the CPU 211 displays an image which is acquired from the result of the processing on the display section 231 and outputs audio from the speaker 232.

The recording section 218 which is connected to the input and output interface 215 records programs which are executed by the CPU 211 and various types of data. A communication section 219 communicates with external devices via the Internet or another network. In addition, programs may be acquired via the communication section 219 and recorded in the recording section 218.

A reader/writer 220 has a configuration which is the same as the reader/writer 54 of FIG. 3. The reader/writer 220 operates according to controls of the CPU 211.

In addition, when a removable medium 222 such as a magnetic disk, an optical disc, a magneto-optical disc, a semiconductor memory, or the like is mounted, a drive 221 which is connected to the input and output interface 215 drives the removable medium 222 and programs, data, and the like which are stored on the removable medium 222 are acquired. The programs and data which are acquired are transferred to the recording section 218 as necessary and recorded.

The personal computer 210 is configured as above.

### [IC Card Data Transfer Control Program]

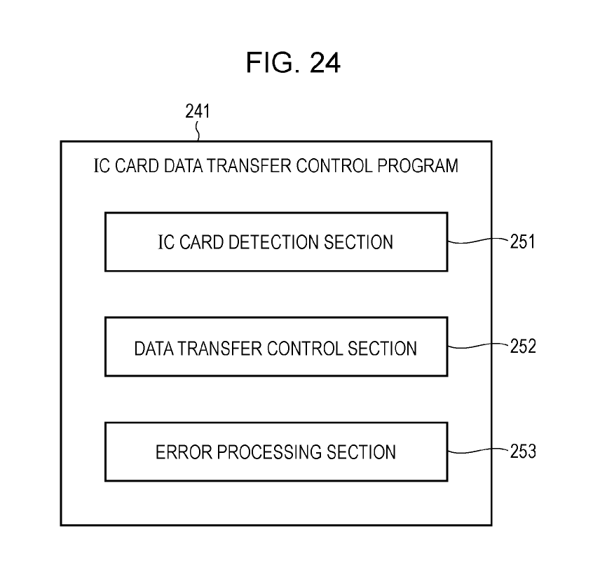

FIG. 24 is a diagram illustrating a configuration of an IC card data transfer control program.

An IC card data transfer control program 241 is executed by either of the CPU 211 or a control section (not shown) of the reader/writer 220.

The IC card data transfer control program 241 is configured from an IC card detection section 251, a data transfer control section 252, and an error processing section 253.

The IC card detection section 251 performs polling and detects the IC card 11 by controlling the reader/writer 220 in the same manner as the IC card detection section 111 of FIG. 4.

The data transfer control section 252 controls data transfer from one of the IC cards 11 to another of the IC cards 11 by controlling the reader/writer 220.

The error processing section 253 notifies of an error which is generated by a process using the IC card detection section 251 or the data transfer control section 252 in the same manner as the error processing section 116 of FIG. 4.

The IC card data transfer control program 241 is configured as above.

### [Flow of IC Card Data Transfer Process]

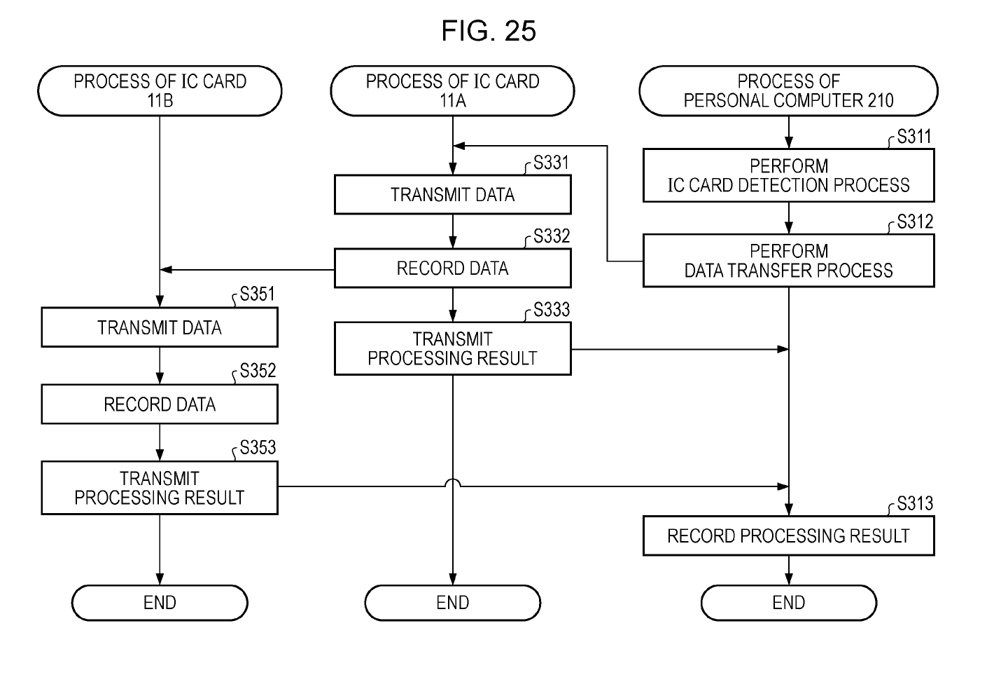

Next, an IC card data transfer process will be described with reference to the flowchart of FIG. 25.

In step S311, the IC card detection section 251 performs an IC card detection process. Since the IC card detection process is the same as the IC card detection process of FIG. 11, the description thereof is omitted.

For example, in the case of detecting the IC card 11A and the IC card 11B using the IC card detection process, the data transfer control section 252 performs a data transfer process in step S312 with regard to the IC card 11A and the IC card 11B.

As the data transfer process, for example, an instruction for data on the IC card 11A to be transferred to the IC card 11B is transmitted to the IC card 11A. Here, the transfer instruction may be transmitted to both the IC card 11A and the IC card 11B.

When the transfer instruction is transmitted from the personal computer 210, the instruction is received in the IC card 11A. Then, in step S331, the control section 34 of the IC card 11A reads out the predetermined data for transfer which is recorded in the recording section 37 and the data is transferred to the IC card 11B (step S332) based on the transfer instruction which has been received.

In step S333, the control section 34 transfers the processing result to the personal computer 210.

When the data is transferred from the IC card 11A, the data is received in the IC card 11B (step S351). Then, in step S352, the control section 34 of the IC card 11B records the data which has been received in the recording section 37. Due to this, the data of the IC card 11A is transferred to the IC card 11B.

In step S353, the control section 34 transfers the processing result to the personal computer 210.

When the transfer process is complete, the processing results from each of the IC cards are received in the personal computer 210. In step S313, the data transfer control section 252 records the processing results which are received from each of the IC cards to the recording section 218. Due to this, not only the processing results in cases where the data is transferred normally but also the processing results in cases where the data transfer may have failed are recorded.

As above, in the IC card data transfer process, the plurality of IC cards 11 which are placed are detected, and the data for transferring on one of the IC cards 11 out of the plurality of IC cards 11 is transmitted to another of the IC cards 11. Due to this, for example, data transfer is possible by only placing the two IC cards 11 with regard to the personal computer 210.

For example, when the data transfer described above is attempted to be performed in a system where only one of the IC cards 11 at a time is able to be placed, first, by the IC card 11A being placed, the data on the IC card 11A is read out by the personal computer 210 and recorded once. Next, an operation is necessary where the data which is recorded is written onto the IC card 11B by the IC card 11B being placed. On the other hand, in the IC card data transfer system 201, since it is possible for the data to be transferred directly from the IC card 11A to the IC card 11B without the data for transfer being recorded in the personal computer 210, it is possible to improve security.

As a specific example of the IC card data transfer system 201, for example, a usage method is assumed where the data on the IC card 11A is carried over to with regard to the IC card 11B when the IC card 11A which has expired is overlapped and placed with the IC card 11B which has been newly issued.

### 3. Third Embodiment

### IC Card Site Induction System

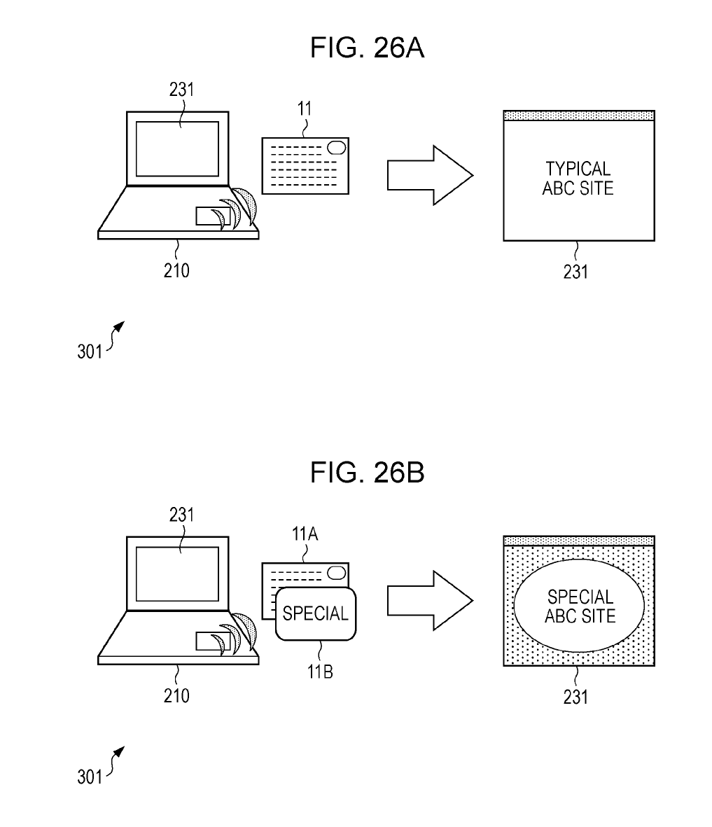

Next, a site induction service will be described with reference to FIGS. 26A to 28.

FIGS. 26A and 26B are diagrams illustrating a configuration example of an IC card site induction system where the present technology is applied.

As shown in FIGS. 26A and 26B, an IC card site induction system 301 is configured from the plurality of IC cards 11 and the personal computer 210.

As shown in FIG. 26A, in a case where one of the IC cards 11 is placed, the personal computer 210 acquires site information (for example, a URL) from accessing the typical site from the IC card 11. The personal computer 210 accesses a typical site via the Internet based on the site information which is acquired and displays the webpage on the display section 231. For example, “typical ABC site” is displayed on the display section 231 as the typical site.

In addition, as shown in FIG. 26B, in a case where the IC card 11A and the IC card 11B are placed, the personal computer 210 accesses information from the IC card 11A and specific information from the IC card 11B. The personal computer 210 accesses a special site via the Internet based on the site information and the specific information and displays the webpage on the display section 231. Here, the specific information is information for accessing the special site which is related to the typical site. For example, “special ABC site” is displayed on the display section 231 as the special site.

Here, the personal computer 210 has the configuration which was shown in FIG. 23 described above.

The IC card site induction system 301 is configured as above.

### [IC Card Site Induction Control Program]

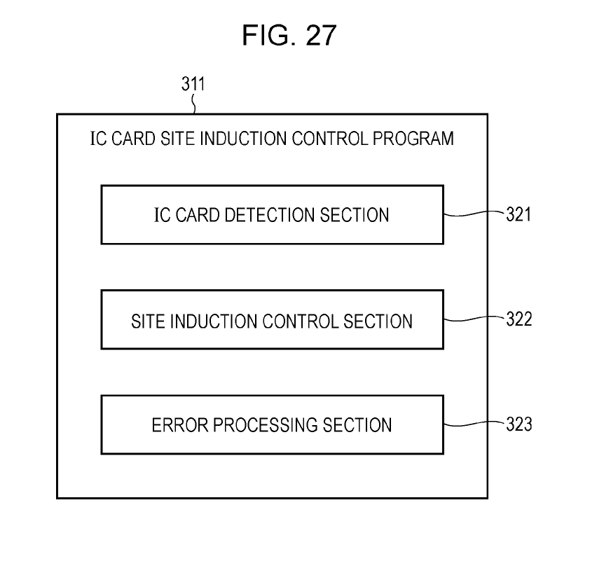

FIG. 27 is a diagram illustrating a configuration of an IC card site induction control program.

An IC card site induction control program 311 is executed using either of the CPU 211 or a control section (not shown) of the reader/writer 220.

The IC card site induction control program 311 is configured from an IC card detection section 321, a site induction control section 322, and an error processing section 323.

The IC card detection section 321 performs polling and detects the IC cards 11 by controlling the reader/writer 220 in the same manner as the IC card detection section 111 of FIG. 4.

The site induction control section 322 acquires site information from the IC card 11 by controlling the reader/writer 220. The site induction control section 322 displays the webpage on the display section 231 by controlling the communication section 219 and accessing the typical site via the Internet based on the site information.

In addition, the site induction control section 322 acquires the site information from one of the IC cards 11 and acquires the specific information from another of the IC cards 11 by controlling the reader/writer 220. The site induction control section 322 displays the webpage on the display section 231 by controlling the communication section 219 and accessing the special site via the Internet based on the site information and the specific information.

The error processing section 323 notifies of an error which is generated by a process using the IC card detection section 321 or the site induction control section 322 in the same manner as the error processing section 116 of FIG. 4.

The IC card site induction control program 311 is configured as above.

### [Flow of IC Card Site Induction Process]

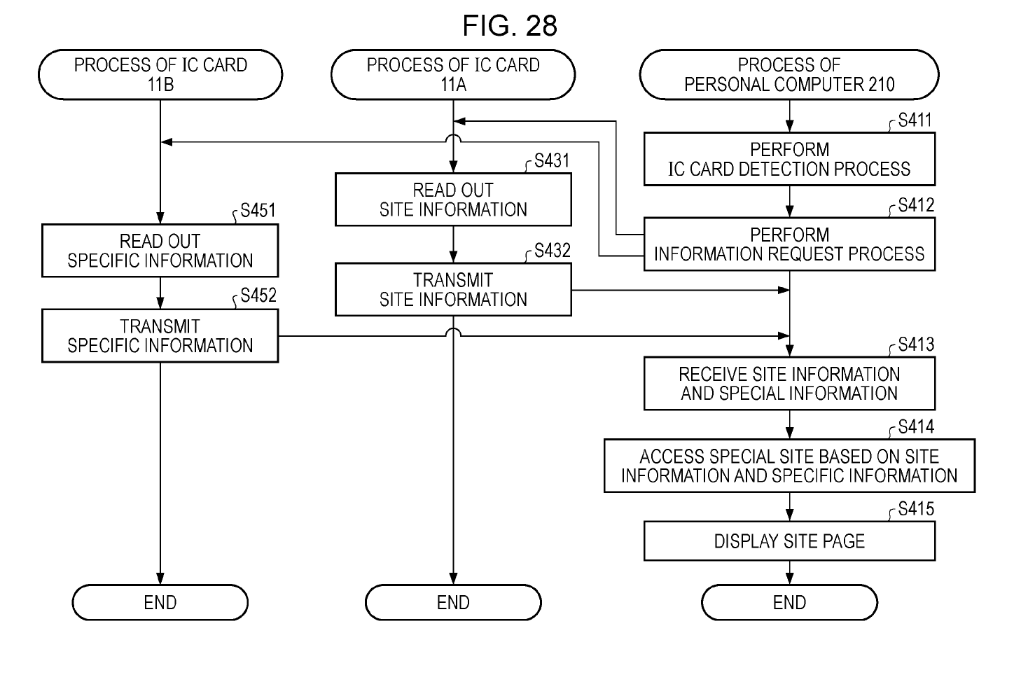

Next, an IC card site induction process will be described with reference to the flowchart of FIG. 28.

In step S411, the IC card detection section 321 performs an IC card detection process. Since the IC card detection process is the same as the IC card detection process of FIG. 11, the description thereof is omitted.

In the case of detecting the IC card 11A and the IC card 11B using the IC card detection process, the site induction control section 322 performs an information request process in step S412 with regard to the IC card 11A and the IC card 11B.

As the information request process, for example, a process is performed where the site information is request with regard to the IC card 11A and the specific information is request with regard to the IC card 11B.

When the request is transmitted from the personal computer 210, the request is received by each of the IC card 11A and the IC card 11B.

In step S431, the control section 34 of the IC card 11A reads out the site information which is recorded in the recording section 37 and transmits the site information to the personal computer 210 (step S432) based on the request which has been received.

In addition, in step S451, the control section 34 of the IC card 11B reads out the specific information which is recorded in the recording section 37 and transmits the specific information to the personal computer 210 (step S452) based on the request which has been received.

When the site information is transmitted from the IC card 11A and the specific information is transmitted from the IC card 11B, this information is received by the communication section 219 of the personal computer 210 (step S413).

In step S414, the site induction control section 322 accesses the special site via the Internet and displays the webpage on the display section 231 (step S415) based on the site information and the specific information.

For example, the “special ABC site” of FIG. 26B is displayed in the display section 231 as the special site.

As above, in the IC card site induction process, the plurality of IC cards which have been placed are detected, the site information and the specific information are acquired from the plurality of IC cards which have been detected, and the webpage is displayed by the specific site being accessed. Due to this, for example, when a specific IC card is placed with regard to the personal computer 210 in addition to the IC card 11A for induction of a normal site, induction to the special site which is not able to be seen by a typical person is possible.

Here, as another example of the IC card site induction system 301, for example, it is possible to realise the provision of a service where a transaction such as a withdrawal or transfer and identification confirmation (authentication) are performed one time by a bank card of a bank with an IC chip embedded and a driver's license which is an IC card being placed by overlapping with regard to an ATM which is able to read IC cards. In addition, for example, it is possible to realise the provision of a service where payment and crediting of points is performed one time by an IC card for payment and an IC card for crediting points being overlapped and placed on a POS terminal device when paying at a store such as a convenience store or a department store.

In addition, for example, it is possible to realise the provision of a service where authentication of age and payment are performed one time by an IC card for identifying adults and an IC card for payment being placed by overlapping on an automatic cigarette disperser. Furthermore, it is possible to provide a service where it is possible to purchase tickets with a group discount by overlapping the IC cards for payment for a plurality of people and placing on a fee payment device when purchasing tickets such as facilities of a transport organization or a tourist area. In addition, for example, it is possible to provide a service where the balance of electronic money, the use history of each IC card, and the like when the plurality of IC cards are placed by overlapping when software (for example, an electronic money viewer) is activated for displaying information such as the balance of electronic money and the use history in the personal computer 210. In this service, there is a merit in that it is not necessary to have to switch the IC cards when confirming the balance of electronic money and the like of the plurality of IC cards.

As above, in the IC card payment system, the IC card data transfer system, and the IC card site induction system where the present technology is applied, it is possible to improve the convenience of a service which uses proximity communication since it is possible to provide various services in a case where the plurality of IC cards are overlapped.

Here, in the description described above, an example is described with the IC card as a communication device which performs proximity communication, but it is possible to also be applied to another electronic device without being limited to the IC card such as a mobile phone unit with an IC card function built in.

In addition, in the description described above, an example is described where the series of processes are executed using software, but the series of processes are able to be also executed using hardware. Then, in a case where the series of processes are executed using software, a program which configures the software is executed by being installed in a computer with specialized hardware built in or by being installed in a general personal computer or the like which is able to execute various processes by installing various programs from a recording medium.

The recording medium is configured from a magnetic disk (which includes a flexible disk), an optical disc (which includes a CD-ROM (Compact Disc Read Only Memory) or a DVD (Digital Versatile Disk), a magneto-optical disc (which includes a MD (MiniDisc) (registered trademark)), a semiconductor memory, or the like where the program is recorded which is distributed separately to the computer for delivery of the program to the user, but also is configured by a recording section configuring the program which is provided to the user in a state of being embedded in the computer in advance.

In addition, the program which executes the series of processes described above may be installed onto the computer via a wired or wireless communication medium such as a local access network, the Internet, or digital satellite broadcasting via an interface such as a router or a modem as necessary.

Here, it is not necessary for the processing steps which describe the process for performing the various processes in the computer in the specifications to be necessarily processed in a time series manner according to the order which is described as a flowchart but may include processes which are executed in parallel or individually (for example, parallel processing or processing using objects).

In addition, the process may be processing using one computer or may be processed in a disperse manner using a plurality of computers. Furthermore, the program may be executed by being transferred to a remote computer.

Here, a system in the specifications is a logical collective configuration of a plurality of devices.

Furthermore, the embodiments of the present technology are not limited to the embodiments described above but various modifications are possible within the scope which does not depart from the concept of the present technology.

The present technology contains subject matter related to that disclosed in Japanese Priority Patent Application JP 2011-075961 filed in the Japan Patent Office on Mar. 30, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a communication device detection section which detects a communication device which performs proximity communication; and
a common processing section which performs common processing with regard to a plurality of the communication devices based on unique information which are acquired from the communication devices which are detected in a case where the plurality of communication devices are detected.

2. The information processing device according to claim 1, further comprising:
a processing result notification section which notifies the plurality of communication devices of the result of the common processing.

3. The information processing device according to claim 2,
wherein the common processing section performs the common processing according to the number of communication devices which have been detected and the unique information which are acquired from the communication devices and determines a value which is requested with regard to each of the communication devices.

4. The information processing device according to claim 3,
wherein the unique information is information which indicates the balance of electronic money, and
the common processing section determines the monetary amount as the payment amount for each of the communication devices in a case where the balances which is acquired for each of the communication devices exceed the monetary amount for splitting the costs which are acquired by dividing the amount to be paid by the number of communication devices.

5. The information processing device according to claim 3,
wherein the unique information is information which indicates the monetary amount of the electronic money which is able to be charged, and
the common processing section determines the monetary amount as the charge amount for each of the communication devices in a case where the monetary amount able to be charged which is acquired for each of the communication devices exceeds the monetary amount which is acquired by dividing the charge amount by the number of communication devices.

6. The information processing device according to claim 3,
wherein the unique information is information which indicates the balance of electronic money, and
the common processing section determines the payment amount according to the balances for each of the communication devices in a case where the monetary amount which is acquired by combining the balances which are acquired for each of the communication devices exceeds the amount to be paid.

7. The information processing device according to claim 1,
wherein the common processing section performs the common processing in a case where the previous processing is completed in a normal manner in one or more of the communication devices out of the plurality of communication devices which are detected.

8. The information processing device according to claim 2, further comprising:
an error notification section which notifies of an error which is generated when the detection of the communication devices, the common processing, or the notification of the result of the common processing is performed.

9. The information processing device according to claim 1, further comprising:
a display section which displays a screen where the content of the common processing is selected.

10. An information processing method comprising:
detecting a communication device which performs proximity communication and performing a common processing with regard to a plurality of the communication devices based on unique information which are acquired from the communication devices which are detected in a case where the plurality of communication devices are detected using an information processing device.

11. A non-transitory recording medium storing a program which makes a computer function as:
a communication device detection section which detects a communication device which performs proximity communication; and
a common processing section which performs common processing with regard to a plurality of the communication devices based on unique information which are acquired from the communication devices which are detected, in a case where the plurality of communication devices are detected.

12. An information processing system:
wherein an information processing device is provided with a communication device detection section which detects a communication device which performs proximity communication, and a common processing section which performs common processing with regard to a plurality of the communication devices based on unique information which are acquired from the communication devices which are detected in a case where the plurality of communication devices are detected.
